(19) United States
(12) Patent Application Publication
(10) Pub. No.: US 2010/0214210 A1
(43) Pub. Date: Aug. 26, 2010

(54) CURRENT BALANCING DEVICE, LED LIGHTING APPARATUS, LCD BACKLIGHT MODULE, AND LCD DISPLAY UNIT

(75) Inventors: Shinji Aso, Niiza-shi (JP); Kengo Kimura, Niiza-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sanken Electric Co., Ltd., Niiza-shi (JP)

(21) Appl. No.: 12/706,115

(22) Filed: Feb. 16, 2010

(30) Foreign Application Priority Data
Feb. 26, 2009 (JP) 2009-044620
Apr. 24, 2009 (JP) 2009-106849

(51) Int. Cl. G09G 3/36; H02J 3/14; H05B 37/02

(52) U.S. Cl. 345/102; 307/32; 315/294

(57) ABSTRACT

The present invention includes: a power supply unit 10 outputting an alternating current; and multiple series circuits each of which is connected to an output of the power supply unit 10 and includes at least one winding N1, S1, at least one rectifying element D1, D2, and at least one load LED1a, 2a, which are connected in series. Currents flowing through the multiple series circuits are balanced based on an electromagnetic force generated at the at least one winding N1, S1.

### TECHNICAL FIELD

The present invention relates to a current balancing device for balancing currents flowing through multiple loads connected in parallel, an LED lighting apparatus, an LCD backlight module, and an LCD display unit.

### BACKGROUND ART

Conventional LED lighting devices in which multiple light emitting diodes (LEDs) are connected in series have been known from, for example, Japanese Patent Application Publications Nos. 2004-319583 (Patent Literature 1) and 2006-12659 (Patent Literature 2).

In the LED lighting device disclosed in Patent Literature 1, multiple LED units each including multiple LEDs connected in series are connected in parallel. If the multiple LED units each including the multiple LEDs connected in series are driven while being connected in parallel, the LED units have different voltage drops (forward voltage Vf of each LED), resulting in unbalanced currents flowing through the LED units connected in parallel. Accordingly, in Patent Literature 1, the currents flowing through the LED units are balanced by applying constant currents to the respective LED units by using a constant current circuit.

In an electric-discharge lamp lighting circuit disclosed in Patent Literature 2, currents flowing through multiple cold cathode fluorescent lamps (CCFLs) connected in parallel are balanced using transformers. Since the CCFLs are driven by an alternating current, sinusoidal currents flow through the balancing transformers. The currents are balanced by connecting the CCFLs and respective balancing transformers in series and by forming a closed circuit with secondary windings of the balancing transformers.

However, in Patent Literature 1, if the constant current circuit is connected, the differences in voltage drop of the LED units result in losses.

In Patent Literature 2, currents are balanced using the balancing transformers, and thus there is no loss due to the different voltages of the CCFLs. However, in the case of LEDs through which only direct currents flow, the direct currents cannot be balanced using transformers. In other words, the higher the frequency is, the smaller the balancing transformers can be made, but the lower the frequency is, the larger the balancing transformers are. In addition, the transformers are saturated with the direct current and cannot be used as the balancing transformers in the LED circuits.

### SUMMARY OF INVENTION

An object of the present invention is to provide a current balancing device, an LED lighting apparatus, an LCD backlight module, and an LCD display unit, in which a loss in a circuit balancing currents flowing through multiple loads having different impedances is reduced to achieve a high efficiency.

A current balancing device according to an aspect of the present invention includes a power supply unit configured to output an alternating current; and a plurality of series circuits each connected to an output of the power supply unit, each series circuit including at least one winding, at least one rectifying element, and at least one load, which are connected in series. In the current balancing device, currents flowing respectively through the plurality of series circuits are balanced based on an electromagnetic force generated at the at least one winding.

An LED lighting apparatus according to an aspect of the present invention includes the current balancing device, and the one load is an LED load.

An LCD backlight module according to an aspect of the present invention includes the current balancing device, and the load is an LED load causing an LCD cell to emit light.

An LCD display according to an aspect of the present invention includes the current balancing device, and the load is an LED load causing an LCD cell to emit light.

### BRIEF DESCRIPTION OF DRAWINGS

FIG. 1 is a configuration diagram of a current balancing device of Embodiment 1 of the present invention.

FIG. 2 shows operation waveforms of the current balancing device of Embodiment 1 of the present invention.

FIG. 3 is a configuration diagram of a current balancing device of Embodiment 2 of the present invention.

FIG. 4 is a configuration diagram of a current balancing device of Embodiment 3 of the present invention.

FIG. 5 is a configuration diagram of a current balancing device of Embodiment 4 of the present invention.

FIG. 6 is a configuration diagram of a current balancing device of Embodiment 5 of the present invention.

FIG. 7 is a configuration diagram of a current balancing device of Embodiment 6 of the present invention.

FIG. 8 shows operation waveforms of the current balancing device of Embodiment 6 of the present invention.

FIG. 9 is a configuration diagram of a current balancing device of Embodiment 7 of the present invention.

FIG. 10 is a configuration diagram of a current balancing device of Embodiment 8 of the present invention.

FIG. 11 shows operation waveforms of the current balancing device of Embodiment 8 of the present invention.

FIG. 12 is a configuration diagram of a current balancing device of Embodiment 9 of the present invention.

FIG. 13 shows operation waveforms of the current balancing device of Embodiment 9 of the present invention.

FIG. 14 is a configuration diagram of a current balancing device of Embodiment 10 of the present invention.

FIG. 15 shows operation waveforms of the current balancing device of Embodiment 10 of the present invention.

FIG. 16 is a configuration diagram of a current balancing device of Embodiment 11 of the present invention.

FIG. 17 shows operation waveforms of the current balancing device of Embodiment 11 of the present invention.

FIG. 18 is a configuration diagram of a current balancing device of Embodiment 12 of the present invention.

FIG. 19 is a configuration diagram of a current balancing device of Embodiment 13 of the present invention.

FIG. 20 is a configuration diagram of a current balancing device of Embodiment 14 of the present invention.

FIG. 21 shows operational waveforms for explaining an operation of resetting balancing transformers of the current balancing device of Embodiment 14 of the present invention.

FIG. 22 shows operation waveforms for explaining the operation of resetting the balancing transformers of the current balancing device of Embodiment 14 of the present invention.

FIG. 23 is a configuration diagram of a current balancing device of Embodiment 15 of the present invention.

FIG. 24 shows operation waveforms for explaining an operation of resetting balancing transformers of the current balancing device of Embodiment 15 of the present invention.

FIG. 25 shows operation waveforms for explaining the operation of resetting the balancing transformers of the current balancing device of Embodiment 15 of the present invention.

FIG. 26 is a configuration diagram of a current balancing device of Embodiment 16 of the present invention.

FIG. 27 is a configuration diagram of a current balancing device of Embodiment 17 of the present invention.

FIG. 28 is a configuration diagram of a current balancing device of Embodiment 18 of the present invention.

FIG. 29 is a configuration diagram of a current balancing device of Embodiment 19 of the present invention.

FIG. 30 is a configuration diagram of a current balancing device of Embodiment 20 of the present invention.

FIG. 31 is a configuration diagram of a current balancing device of Embodiment 21 of the present invention.

### DESCRIPTION OF EMBODIMENTS

Hereinafter, power supply apparatuses provided with current balancing devices according to embodiments of the present invention are described in detail with reference to the drawings.

At first, a transformer can balance an alternating current but cannot balance direct currents in a direct current-driving circuit such as an LED. The present invention includes multiple series circuits each of which is connected to an output of a power supply unit outputting an alternating current and includes at least one winding, at least one rectifying element, and at least one load which are connected in series and is characterized by balancing currents flowing through the multiple series circuits based on electromagnetic force generated at the at least one winding.

Each embodiment described below shows an example of the current balancing device where the loads having different impedances are LEDs.

### Embodiment 1

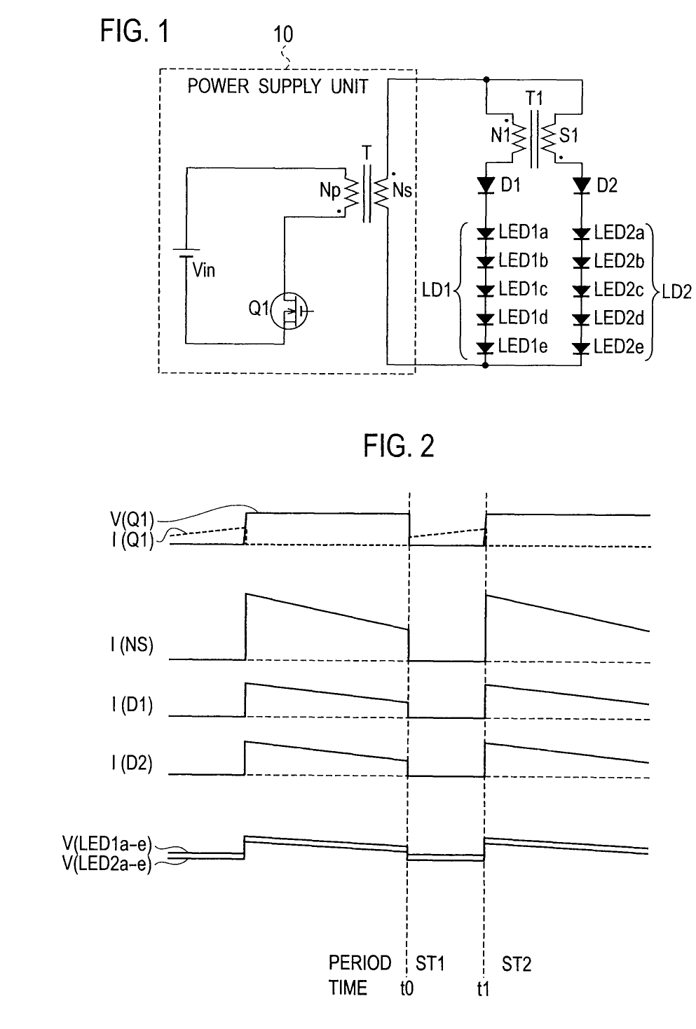

FIG. 1 is a configuration diagram of a current balancing device according to Embodiment 1 of the present invention.

In Embodiment 1 shown in FIG. 1, a power supply unit 10 supplying an alternating current includes: a direct current (DC) power supply Vin; a series circuit including a primary winding Np of a transformer T connected to both ends of the DC power supply Vin and a switching element Q1 configured of a MOSFET; and a secondary winding Ns of the transformer T. The switching element Q1 is turned on and off and thereby an alternating current is outputted from both ends of the secondary winding Ns of the transformer T.

An end of the secondary winding Ns of the transformer T is connected to an end of a winding N1, and the other end of the winding N1 is connected to an anode of a diode D1 which half-wave rectifies the alternating current. Between a cathode of the diode D1 and the other end of the secondary winding Ns, a load LD1 (LEDs la to 1e) is connected. In Embodiment 1, a first series circuit is composed of the winding N1, diode D1, and load LD1.

The end of the secondary winding Ns of the transformer T is also connected to an end of a winding S1, and the other end of the winding S1 is connected to an anode of a diode D2 which half-wave rectifies the alternating current. Between a cathode of the diode D2 and the other end of the secondary winding Ns, a load LD2 (LEDs 2a to 2e) is connected. In Embodiment 1, a second series circuit is composed of the winding S1, diode D2, and load LD2. The windings N1 and S1 are electromagnetically coupled to each other, constituting a transformer T1. The impedance of the load LD1 is different from the impedance of the load LD2 in Embodiment 1.

FIG. 2 shows operation waveforms of the current balancing device according to Embodiment 1 of the present invention. In FIG. 2, V(Q1) denotes a drain-source voltage of the switching element Q1; I(Q1), the current flowing through the drain of the switching element Q1; I(NS), the current flowing through the secondary winding Ns of the transformer T; I(D1) and I(D2), currents flowing through the diodes D1 and D2; V(LED1a-e), a voltage across the load LD1 (LEDs la to 1e); and V(LED2a-e), a voltage across the load LD2 (LEDs 2a to 2e).

First, at time t0, the switching element Q1 is on. The beginning of the winding Np of the transformer T has a negative potential, and the beginning of the winding Ns also has a negative potential. During a period ST1 starting from the time t0, because of the diodes D1 and D2 included in the series circuits, the alternating current supplied from the winding Ns does not flow through the first and second series circuits connected to the winding Ns. There is no current flowing through the transformer T and first and second series circuits. Accordingly, a magnetizing current of the transformer T flows through a path of Vin→Np→Q1→Vin.

When the switching element Q1 is turned off at time t1, the magnetizing current stored in the transformer T during the period ST1 generates counter-electromotive force with a positive potential at the beginning of the winding Np, and thus the beginning of the winding Ns also has a positive potential. Accordingly, during the period ST2 starting from the time t1, the diodes connected to the series circuits conduct the current. The current flows through the path of Ns→N1→D1→load LD1→Ns and the path of Ns→S1→D2→load LD2→Ns. In such a manner, the currents I(D1) and I(D2) whose magnitude change with time, that is, which have alternating components, flow through the individual series circuits.

The currents I(D1) and I(D2) flow through the windings N1 and S1, respectively, thus generating magnetic flux according to the currents. Since the windings N1 and S1 constitute the transformer T1, at this time, the magnetic fluxes generated at the individual windings interact with each other so that the magnitudes of the magnetic fluxes are equalized. Accordingly, even when the magnitudes of the currents I(D1) and I(D2) are originally different from each other, the currents I(D1) and I(D2) are balanced (equalized) in magnitude to a certain value and supplied to the loads LD1 and LD2. In such a manner, the loads LD1 and LD2 have different impedances, but the magnitudes of the currents I(D1) and I(D2) of the first and second series circuits are equal to each other.

In Embodiment 1, the currents are balanced in magnitude by the electromagnetic forces generated at the windings. Accordingly, there occurs a loss mainly due to the winding resistances. This loss is smaller than the loss in the constant current circuit of Patent Literature 1, and the loss in the balancing circuit can be thus reduced.

Embodiment 1 illustrates a lighting device including the loads LD1 and LD2 each including multiple LEDs connected in series. Accordingly, supplying the balanced currents to the loads LD1 and LD2 allows the multiple LEDs to uniformly emit light, thus illuminating a liquid crystal display (LCD) uniformly, for example.

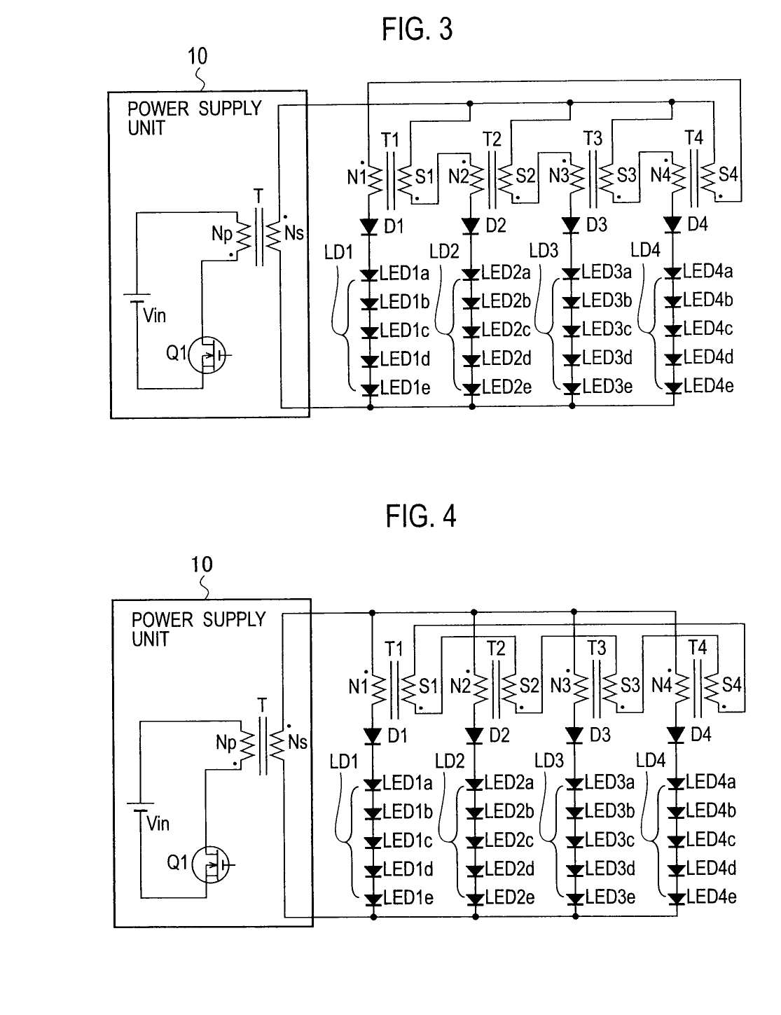

Embodiments 2 to 5 shown in FIGS. 3 to 6 illustrate some methods of electromagnetically coupling transformers to each other so as to equalize winding currents when multiple series circuits are connected to the power supply unit 10.

### Embodiment 2

FIG. 3 is a configuration block diagram of a current balancing device according to Embodiment 2 of the present invention. In Embodiment 2 shown in FIG. 3, the output of the power supply unit 10 is connected to: a series circuit composed of a winding S4, a winding N1, a diode D1, and a load LD1 including LEDs 1a to 1e; a series circuit composed of a winding S1, a winding N2, a diode D2, and a load LD2 including LEDs 2a to 2e; a series circuit composed of a winding S2, a winding N3, a diode D3, and a load LD3 including LEDs 3a to 3e; and a series circuit composed of a winding S3, a winding N4, a diode D4, and a load LD4 including LEDs 4a to 4e.

The winding N1 (N2, N3, and N4) and the winding S1 (S2, S3, and S4) are magnetically coupled so that a current half-wave rectified by the diode D1 (D2, D3, and D4) is balanced, thus constituting the transformer T1 (T2, T3, and T4).

In other words, each series circuit includes two windings connected in series, and the two windings are electromagnetically coupled to each other in such a manner as to serve as the primary and secondary windings of the transformer, respectively.

In the connection of Embodiment 2, currents flowing through the winding N1 (N2, N3, and N4) and the winding S1 (S2, S3, and S4) of the transformer T1 (T2, T3, and T4) are equal to each other because of the characteristics thereof. The current supplied from the power supply unit 10 can be equally distributed to the loads LD1 to LD4. Accordingly, Embodiment 2 can provide a similar effect to that of the current balancing device according to Embodiment 1. Moreover, two windings are connected in each series circuit. Accordingly, the transformers can be reduced in size as a balancing transformer and the same transformer can be used for the two windings.

### Embodiment 3

FIG. 4 is a configuration block diagram of a current balancing device according to Embodiment 3 of the present invention. In Embodiment 3 shown in FIG. 4, the output of the power supply unit 10 is connected to: a series circuit composed of a winding N1, a diode D1, and a load LD1 including LEDs 1a to 1e; a series circuit composed of a winding N2, a diode D2, and a load LD2 including LEDs 2a to 2e; a series circuit composed of a winding N3, a diode D3, and a load LD3 including LEDs 3a to 3e; and a series circuit composed of a winding N4, a diode D4, and a load LD4 including LEDs 4a to 4e.

The windings S1 to S4 are connected to one another in a closed loop, and the winding N1 (N2, N3, and N4) and the winding S1 (S2, S3, and S4) are electromagnetically coupled to each other, constituting a transformer T1 (T2, T3, and T4). Specifically, the series circuits respectively include first windings, and second windings are electromagnetically coupled to the first windings, respectively. The second windings are connected to each other in series to form a closed loop. An equal current flows through the windings S1 to S4.

A current half-wave rectified by the diode D1 (D2, D3, and D4) flows through the winding N1 (N2, N3, and N4). The winding N1 (N2, N3, and N4) and the winding S1 (S2, S3, and S4) are magnetically coupled to each other so that the current flowing through the winding N1 (N2, N3, and N4) is balanced with the current flowing through the winding S1 (S2, S3, and S4), constituting the transformer T1 (T2, T3, and T4). Accordingly, in the connection of Embodiment 3, the currents flowing through the winding N1 (N2, N3, and N4) and the winding S1 (S2, S3, and S4) of the transformer T1 (T2, T3, and T4) are equal to each other because of the characteristics thereof. The current supplied from the power supply unit 10 can be equally distributed to the loads LD1 to LD4. Accordingly, the current balancing device according to Embodiment 3 can provide a similar effect to that of the current balancing device according to Embodiment 1. Moreover, the same transformer to serve as a balancing transformer can be used for the current.

### Embodiment 4

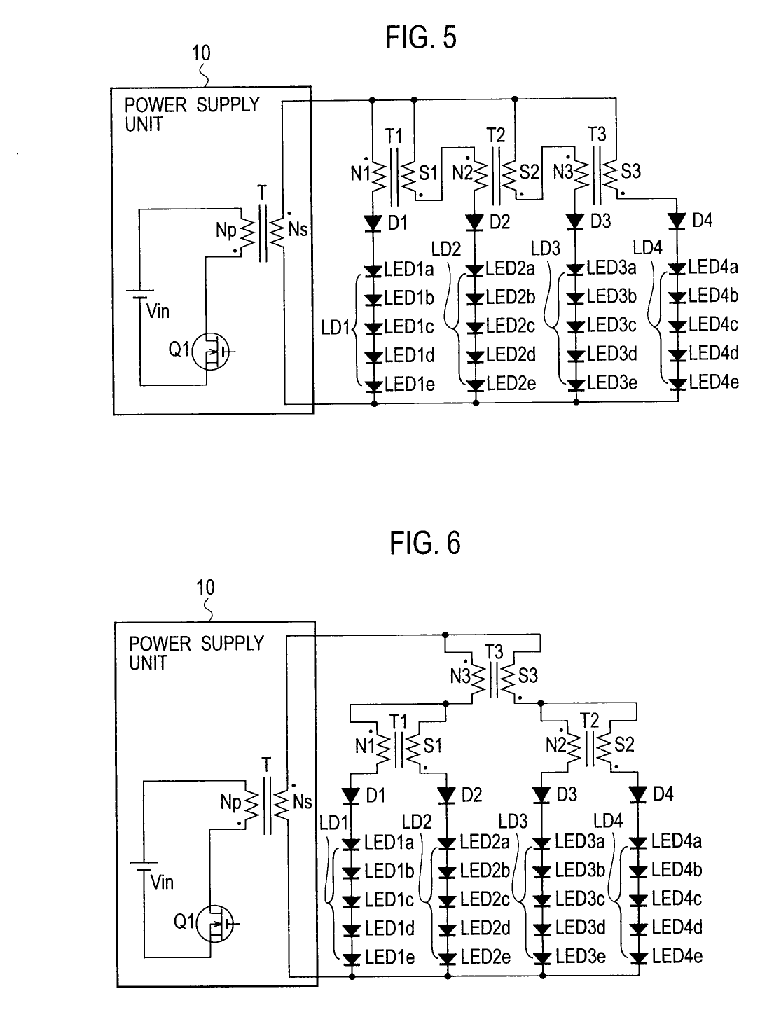

FIG. 5 is a configuration block diagram of a current balancing device according to Embodiment 4 of the present invention. In Embodiment 4 shown in FIG. 5, the output of the power supply unit 10 is connected to: a series circuit composed of a winding N1, a diode D1, and a load LD1 including LEDs 1a to 1e; a series circuit composed of windings S1 and N2, a diode D2, and a load LD2 including LEDs 2a to 2e; a series circuit composed of windings S2 and N3, a diode D3, and a load LD3 including LEDs 3a to 3e; and a series circuit composed of a winding S3, a diode D4, and a load LD4 including LEDs 4a to 4e.

The winding N1 (N2 and N3) and the winding S1 (S2 and S3) are magnetically coupled to each other so that currents to be half-wave rectified by the diodes can be balanced, constituting a transformer T1 (T2 and T3). Specifically, the current balancing device includes series circuits including a single winding and series circuits each including two windings electromagnetically coupled to each other as the primary and secondary windings of the transformers.

In the connection of Embodiment 4, currents flowing through the winding N1 (N2 and N3) and the winding S1 (S2 and S3) of the transformer T1 (T2 and T3) are equal to each other because of the characteristics thereof. The current supplied from the power supply unit 10 can be equally distributed to the loads LD1 to LD4. Accordingly, the current balancing device according to Embodiment 4 can provide a similar effect to that of the current balancing device according to Embodiment 1. Moreover, the transformer T4 composed of the windings N4 and S4, which is included in Embodiments 2 and 3, can be eliminated in Embodiment 4, and thus the current balancing device thereof can be configured at low cost.

### Embodiment 5

FIG. 6 is a configuration block diagram of a current balancing device according to Embodiment 5 of the present invention. In Embodiment 5 shown in FIG. 6, the output of the power supply unit 10 is connected to: a series circuit composed of windings N3 and N1, a diode D1, and a load LD1 including LEDs 1a to 1e; a series circuit composed of windings N3 and S1, a diode D2, and a load LD2 including LEDs 2a to 2e; a series circuit composed of windings S3 and N2, a diode D3, and a load LD3 including LEDs 3a to 3e; and a series circuit composed of windings S3 and S2, a diode D4, and a load LD4 including LEDs 4a to 4e.

The winding N1 (N2 and N3) and the winding S1 (S2 and S3) are magnetically coupled to each other so that currents to be half-wave rectified by the diodes can be balanced to constitute constituting a transformer T1 (T2 and T3). In the connection of Embodiment 5, currents flowing through the winding N1 (N2 and N3) and the winding S1 (S2 and S3) of the transformer T1 (T2 and T3) are equal to each other because of the characteristics thereof. The current supplied from the power supply unit 10 can be equally distributed to the loads LD1 to LD4. Accordingly, the current balancing device according to Embodiment 5 can provide a similar effect to that of the current balancing device according to Embodiment 1. Moreover, in Embodiment 5, the transformer T4 composed of the windings N4 and S4, which is included in Embodiments 2 and 3, can be eliminated, and thus the current balancing device of Embodiment 5 can be configured at low cost.

### Embodiment 6

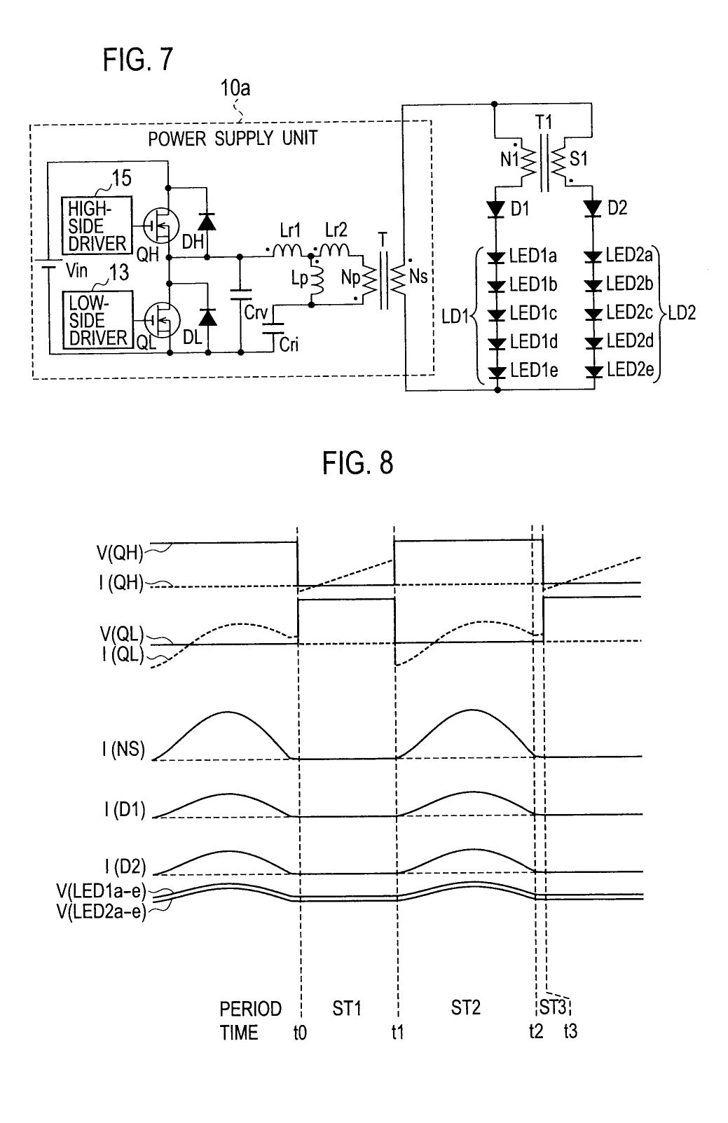

FIG. 7 is a configuration diagram of a current balancing device according to Embodiment 6 of the present invention, which is characterized in that an alternating current supplied from a power supply unit 10a is sinusoidal.

In Embodiment 6 shown in FIG. 7, to supply the sinusoidal alternating current, a series circuit including a switching element QH configured of a MOSFET and a switching element QL configured of a MOSFET is connected to both ends of the DC power supply Vin. A series resonant circuit composed of a primary winding Np of the transformer T and a current resonant capacitor Cri is connected to the connection points of the switching elements QH and QL. The transformer T includes leakage inductances Lr1 and Lr2. Reference letter Lp denotes a magnetizing inductance of the transformer T. A low-side driver 13 drives the switching element QL, and a high-side driver 15 drives the switching element QH.

The switching elements QL and QH are alternately turned on and off to supply the sinusoidal current from the winding Ns of the transformer T, the sinusoidal current generated by resonance of the leakage inductances Lr1 and Lr2 and the current resonant capacitor Cri.

FIG. 8 shows operation waveforms of the current balancing device according to Embodiment 6 of the present invention. In FIG. 8, V(QH) denotes a drain-source voltage of the switching element QH; I(QH), a current flowing through the drain of the switching element QH; V(QL), a drain-source voltage of the switching element QL; I(QL), a current flowing through the drain of the switching element QL; I(NS), a current flowing through the winding Ns; I(D1), a current flowing through the diode D1; I(D2), a current flowing through the diode D2; V(LED1a-e), a voltage across the load LD1; and V(LED2a-e), a voltage across the load LD2.

First, at time t0, when the switching element QH is turned on while the switching element QL is off, the beginning of the winding Np of the transformer T has a negative voltage, and the beginning of the winding Ns also has a negative voltage. Accordingly, in a period ST1 starting from the time t0, the alternating current supplied from the winding Ns does not flow because of the diodes D1 and D2 included in the first and second series circuits connected to the winding Ns. Accordingly, no current flows through the first and second series circuits. The current I(QH) flowing through the switching element QH starts from the minus side to flow through a path of Vin (positive electrode)→QH (DH)→Lr1→Lp→Cri→Vin (negative electrode). Because of the resonance of the current resonant capacitor Cri, the magnetizing inductance Lp, and the leakage inductance Lr1, the magnitude of the current I(QH) increases with time. At this time, the current resonant capacitor Cri is charged.

Next, at time t1, when the switching element QH is turned off and the switching element QL is turned on, the current having flown to the magnetizing inductance Lp starts to flow through the path of Lp→Cri→DL(QL)→Lr1→Lp. The beginning of the winding Np has a positive voltage, and the beginning of the winding Ns also has a positive voltage.

Accordingly, in a period ST2 starting from the time t1, the diodes D1 and D2 connected to the first and second series circuits begin to conduct the current, and the current flows through the path of Ns→N1→D1→load LD1→Ns, which passes the winding N1, and the path of Ns→S1→D2→load LD2→Ns.

This current is supplied from the current resonant capacitance Cri through the transformer T in the path of Cri→Np→Lr2→Lr1→QL(DL)→Cri. This causes resonance of the current resonant capacitor Cri and the leakage inductances Lr1 and Lr2, thus supplying the sinusoidal half-wave current. In such a manner, the currents I(D1) and I(D2), whose magnitudes change with time, that is, which have alternating components, flow through the respective series circuits. The current balancing device according to Embodiment 6 can provide a similar effect to that of the current balancing device according to Embodiment 1. Furthermore, the sinusoidal current flows through the current balancing circuit. Accordingly, there is less noise generated in the current balancing device according to Embodiment 6 than in the current balancing device according to Embodiment 1.

The power supply unit 10a according to Embodiment 6 can be connected to the multiple series circuits shown in Embodiments 2 to 5.

### Embodiment 7

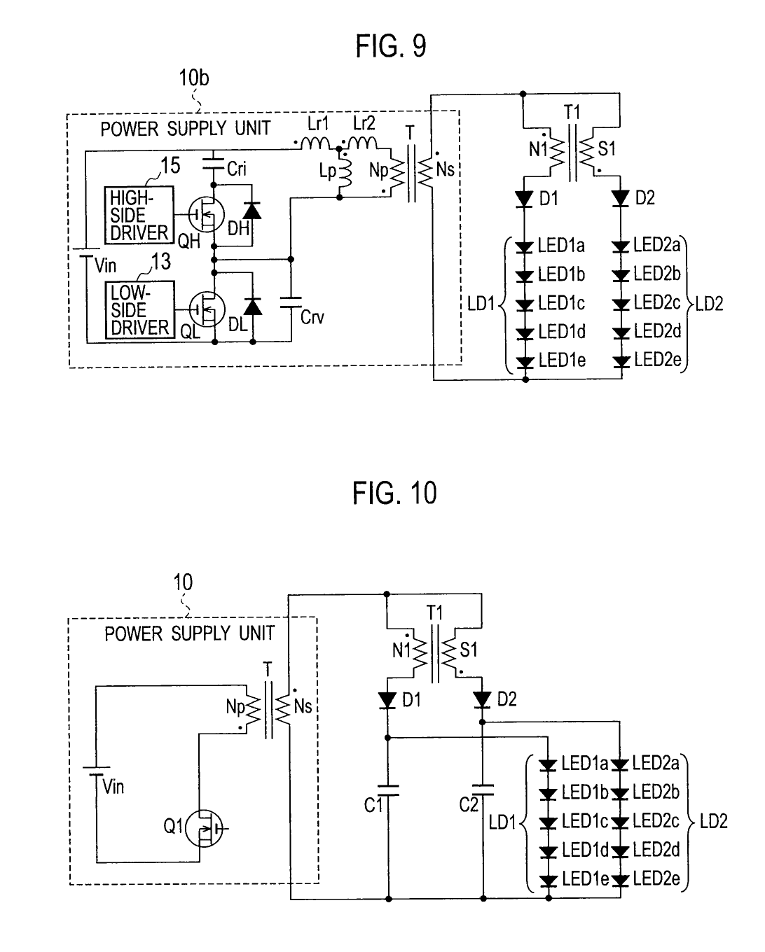

FIG. 9 is a configuration diagram of a current balancing device according to Embodiment 7 of the present invention, which is characterized in that an alternating current supplied from a power supply unit 10b is sinusoidal. The current balancing device according to Embodiment 7 is different from that according to Embodiment 6 in employing active clamp flyback on the input side of the transformer T.

In Embodiment 7 shown in FIG. 9, both ends of a DC power supply Vin are connected to a series resonant circuit including the primary winding Np of the transformer T and a voltage resonant capacitor Cry. Both ends of the voltage resonant capacitor Cry are connected to a switching element QL and a diode DL.

Both ends of the primary winding Np of the transformer Tare connected to a series circuit including a current resonant capacitor Cri and a switching element QH. Both ends of the switching element QH are connected to a diode DH. The transformer T includes leakage inductances Lr1 and Lr2. Reference letter Lp denotes a magnetizing inductance of the transformer T. The diodes DL and DH may be parasitic diodes Di of the switching elements QL and QH.

The power supply unit 10b according to Embodiment 7 is obtained by changing the configuration of the power supply unit 10a of Embodiment 6. The DC power supply Vin and the current resonant capacitor Cri are replaced with each other. The operation of Embodiment 7 provides the operation waveforms approximately the same as those of the operation of Embodiment 6, and the alternating current supplied from the power supply unit 10b according to Embodiment 7 is sinusoidal. The current balancing device according to Embodiment 7 therefore can provide a similar effect to that of the current balancing device according to Embodiment 6.

Note that the power supply unit 10b according to Embodiment 7 can be connected to the multiple series circuits shown in Embodiments 2 to 5.

### Embodiment 8

FIG. 10 is a configuration diagram of a current balancing device according to Embodiment 8 of the present invention, which is characterized in that the alternating current supplied from the power supply unit 10 is smoothed and supplied to loads.

In Embodiment 8 shown in FIG. 10, both ends of the power supply unit 10 supplying the alternating current are connected to: a first series circuit composed of a winding N1, a diode D1 which half-wave rectifies the alternating current, and a load LD1 (LEDs 1a to 1e); and a second series circuit composed of a winding S1, a diode D2 which half-wave rectifies the alternating current, and a load LD2 (LEDs 2a to 2e). The diode D1 (D2) is connected to a smoothing capacitor C1 (C2) in parallel to the load LD1 (load LD2). In other words, the current balancing device according to Embodiment 8 is different from the current balancing device according to Embodiment 1 in including the smoothing capacitors C1 and C2.

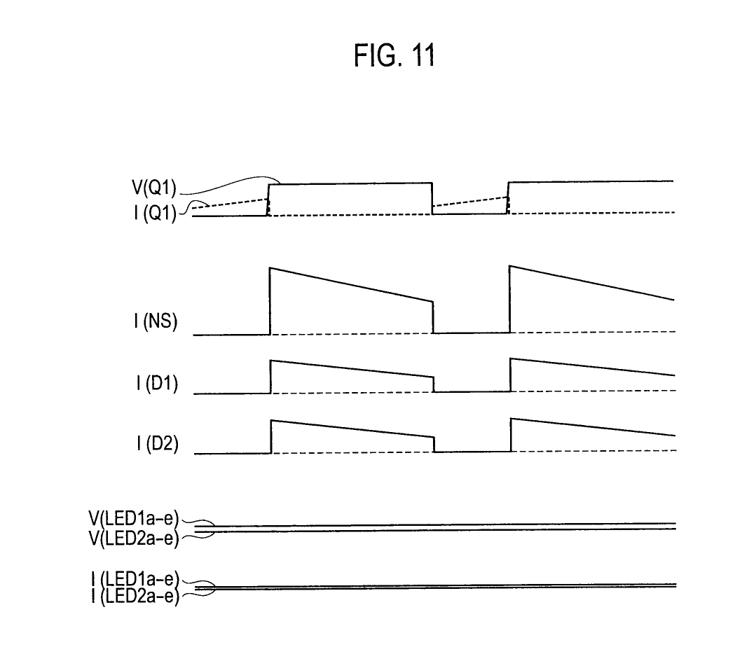

FIG. 11 shows operation waveforms of the current balancing device according to Embodiment 8. In the current balancing device according to Embodiment 8, currents smoothed by the capacitors C1 and C2 are supplied to the loads, and thus load currents I(LED1a-e) and I(LED2a-e) are smoothed currents. Since the loads can be supplied with the smoothed currents, the current balancing device according to Embodiment 8 can provide a similar effect to that of the current balancing device according to Embodiment 1. Moreover, the peaks of the currents flowing through the loads are lowered, thus reducing stresses applied to the loads.

Note that the power supply unit 10 according to Embodiment 8 can be replaced with the power supply units 10a and 10b according to Embodiments 6 and 7. Moreover, the smoothing capacitors C1 and C2 according to Embodiments 8 can be applied to the multiple series circuits shown in Embodiments 2 to 5.

### Embodiment 9

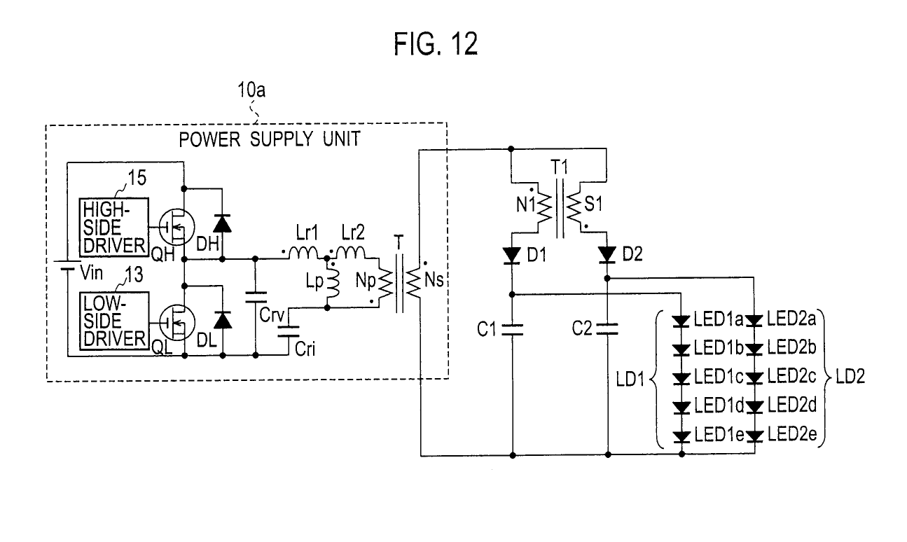

FIG. 12 is a configuration diagram of a current balancing device according to Embodiment 9 of the present invention, which is characterized in that the alternating current supplied from the power supply unit 10a is smoothed and supplied to loads. In Embodiment 9 shown in FIG. 12, the currents smoothed by the capacitors C1 and C2 are supplied to the loads, and thus the load currents I(LED1a-e) and I(LED2a-e) are smoothed currents. Since the loads can be supplied with the smoothed currents, the current balancing device according to Embodiment 9 can provide a similar effect to that of the current balancing device according to Embodiment 6. The peaks of the currents flowing through the loads are lowered, thus resulting stresses applied to the loads.

Note that the power supply unit 10a according to Embodiment 9 can be replaced with the power supply unit 10b according to Embodiment 7.

### Embodiment 10

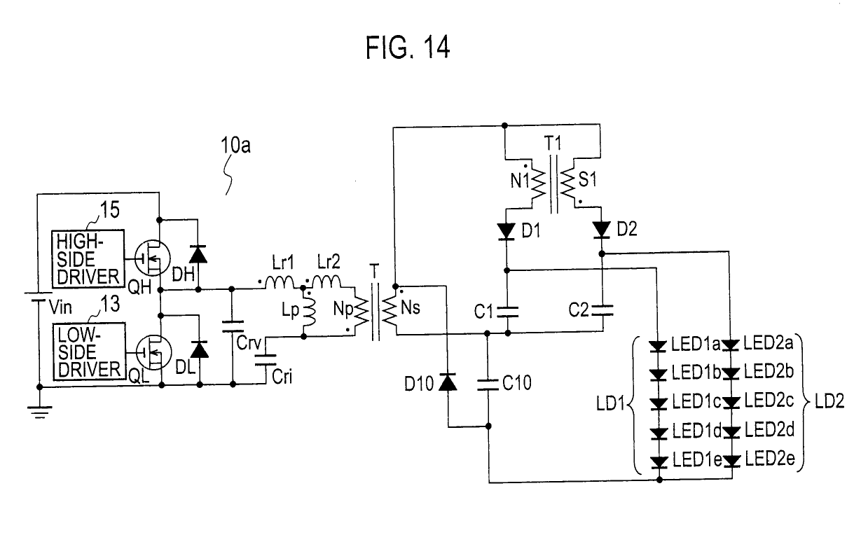

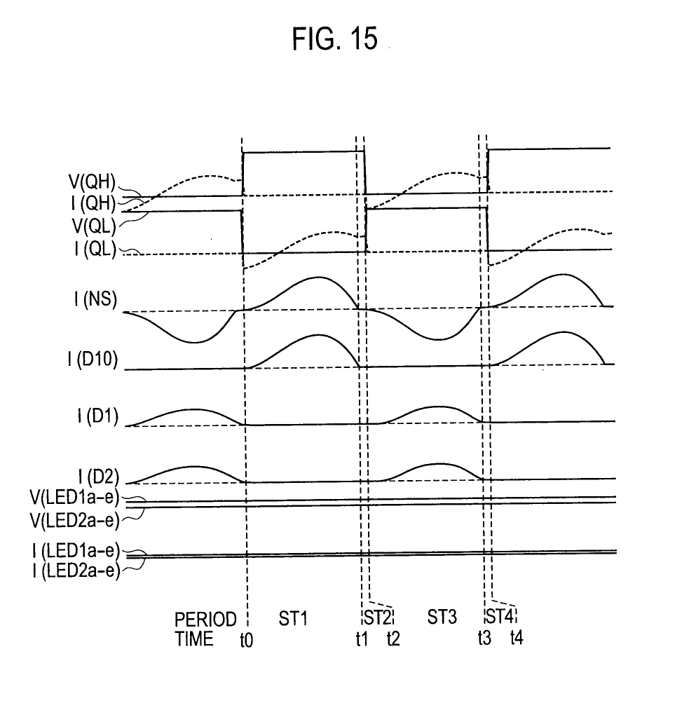

FIG. 14 is a configuration diagram of a current balancing device according to Embodiment 10 of the present invention, which is characterized in that the alternating current supplied from the power supply unit 10a is full-wave rectified.

In Embodiment 10 shown in FIG. 14, both ends of the power supply unit 10a supplying the sinusoidal alternating current are connected to: a first series circuit composed of a winding N1, a diode D1 which half-wave rectifies the alternating current, and a load LD1 (LEDs 1a to 1e); and a second series circuit composed of a winding S1, a diode D2 which half-wave rectifies the alternating current, and a load LD2 (LEDs 2a to 2e). The diode D1 (D2) is connected to a smoothing capacitor C1 (C2) in parallel to the load LD1 (load LD2). Moreover, the load LD1 (load LD2) is connected to the power supply unit 10a through a capacitor C10 and a diode D10 is connected between the connection point of the load LD1 (load LD2) and the capacitor C10 and the winding N1 (S1). In other words, the current balancing device according to Embodiment 10 is different from the current balancing device according to Embodiment 9 in that the loads are supplied with the currents smoothed by the capacitors C1 and C2 and the current generated by smoothing the half-wave current for a negative voltage generated at the winding Ns with the capacitor C10.

FIG. 15 shows operation waveforms of the current balancing device according to Embodiment 10 of the present invention.

First, at time t0, when the switching element QL is turned on while the switching element QH is off, the beginning of the winding Np then has a negative voltage, and the beginning of the winding Ns also has a negative voltage. Accordingly, during a period ST1 starting from the time t0, a reverse voltage is applied to the diodes D1 and D2, and there is no current flowing through the first and second series circuits.

However, a forward voltage is applied to the diode D10, and the current flows from the winding Ns in the path of Ns→C10→D10→Ns. This current is supplied from the winding Np through the transformer T, and the current I(QL) starts from the minus side to flow in the path of Cri→Np→QL(DL)→Cri and becomes a sinusoidal half-wave current because of the resonance of the current resonant capacitor Cri and the inductances Lr1 and Lr2. The magnitude of the current I(QL) increases with time to reach zero at time t1.

Next, at time t2, when the switching element QL is turned off and the switching element QH is turned on, the current having flown to the inductance Lp starts to flow in the path of Lp→Lr1→QH(DH)→Vin→Cri→Lp. The beginning of the winding Np of the transformer T then has a positive voltage, and the beginning of the winding Ns also has a positive voltage. Accordingly, in a period ST3 starting from the time t2, the diodes D1 and D2 connected to the series circuits conduct the current, and the current flows in the path of Ns→N1→D1→load LD1→Ns, which passes the winding N1, and in the path of Ns→S1→D2→load LD2→Ns.

This current then flows in the path of Vin→QH(DH)→Lr1→Lr2→Np→Cri→Vin and is supplied from Vin through the transformer T. The resonance of the current resonant capacitor Cri and leakage inductances Lr1 and Lr2 then supplies the sinusoidal half-wave current.

In such a manner, the currents I(D1) and I(D2), whose magnitudes change with time, that is, which have alternating components, flow through the respective series circuits. The current balancing device according to Embodiment 10 can therefore provide a similar effect to that of the current balancing device according to Embodiment 1. Moreover, in this embodiment, the full wave of the output current of the transformer T is used, thus increasing the utilization of the transformer T. The transformer T can be therefore miniaturized, and thus the current balancing device can be configured at low cost.

Note that the power supply unit 10a according to Embodiment 10 can be replaced with the power supply unit 10 or 10b according to Embodiments 1 or 7. The capacitors C10 and diode D10 according to Embodiment 10 can be applied to multiple series circuits shown in Embodiments 2 to 5.

### Embodiment 11

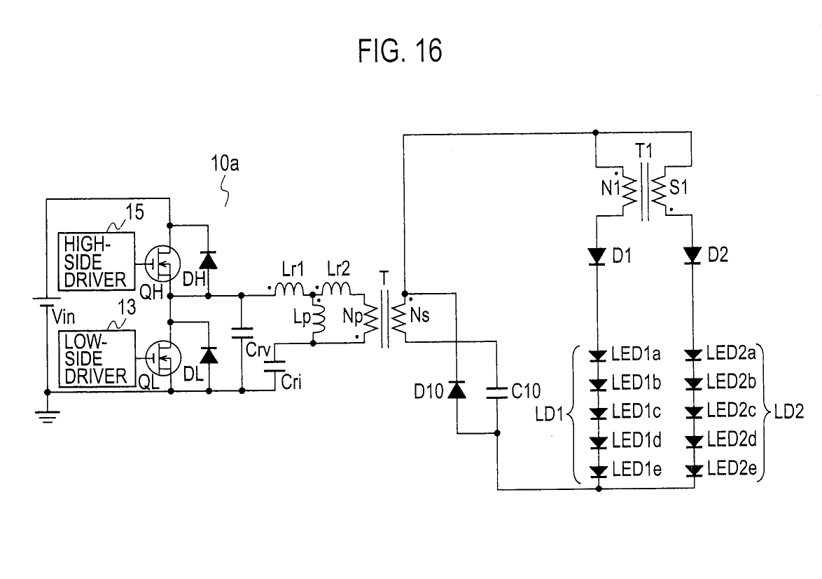

FIG. 16 is a configuration diagram of a current balancing device according to Embodiment 11 of the present invention, which is characterized in that the alternating current supplied from the power supply unit 10a is full-wave rectified and smoothed currents are supplied to loads.

The current balancing device of Embodiment 11 shown in FIG. 16 is configured in such a manner that a diode D10 and a capacitor C10 are added to the configuration in Embodiment 6 shown in FIG. 7 and thereby the alternating current supplied from the power supply unit 10a is smoothed by the capacitor C10 and then supplied to the loads. In Embodiment 11, use of the full wave of the output of the transformer T enhances the utilization rate of the transformer T, and the transformer T can be miniaturized. Moreover, compared to Embodiment 10 shown in FIG. 14, the capacitors C1 and C2 can be eliminated. Accordingly, the current balancing device of Embodiment 11 can be configured at low cost.

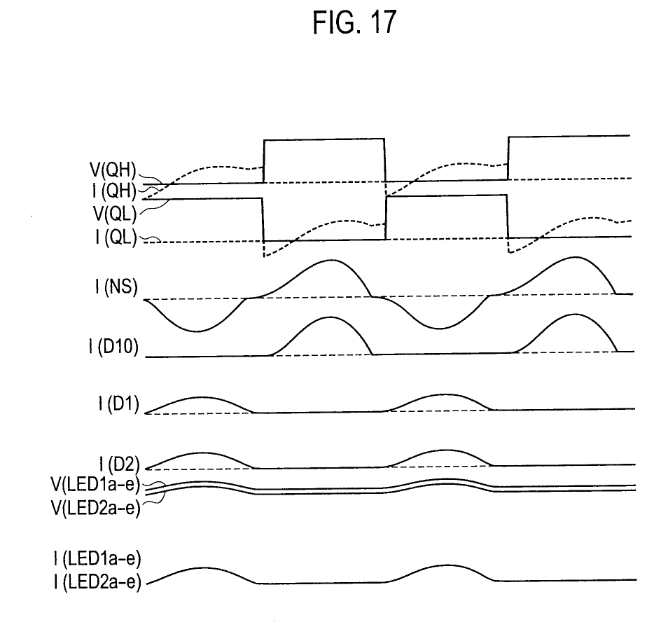

FIG. 17 shows operation waveforms of the current balancing device according to Embodiment 11 of the present invention. The operation waveforms of Embodiment 11 of FIG. 17 are combinations of some of the operation waveforms shown in FIG. 8 in Embodiment 6 of FIG. 7, the description thereof is omitted.

The power supply unit 10a according to Embodiment 11 can be replaced with one of the power supplies 10 or 10b according to Embodiment 1 or 7. Moreover, the capacitor C10 and the diode D10 according to Embodiment 11 can be applied to the multiple series circuits shown in Embodiments 2 to 5.

### Embodiment 12

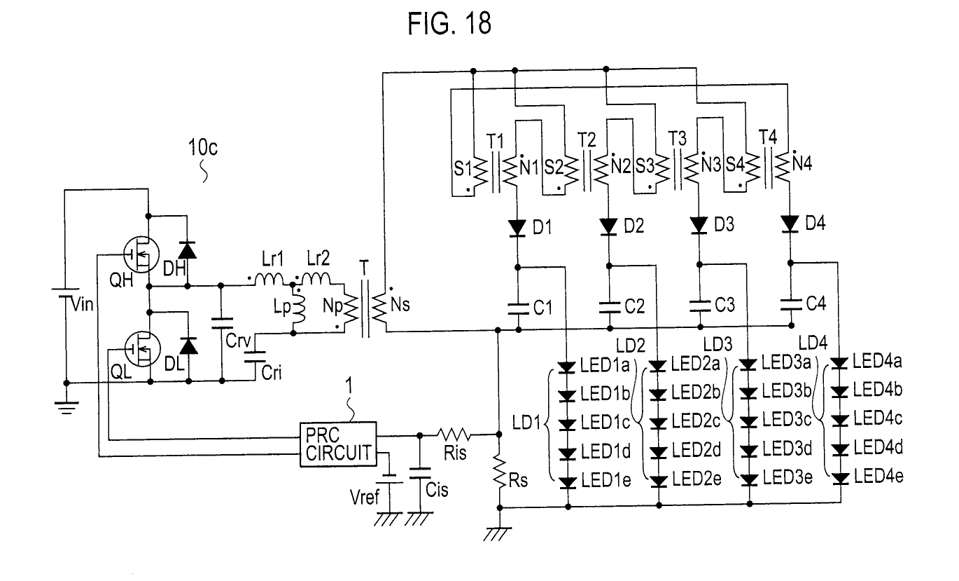

FIG. 18 is a configuration diagram of a current balancing device according to Embodiment 12 of the present invention, which is characterized by including: a current detector for detecting currents of multiple series circuits; a comparator for comparing a current detection value detected by the current detector with a reference voltage; and a controller for controlling the alternating currents according to the output of comparator.

The current balancing device according to Embodiment 12 shown in FIG. 18 includes a power supply unit 10c having the same configuration as that of the power supply unit 10a according to Embodiment 6. The output of the power supply unit 10c is connected to the series circuits according to Embodiment 2, and a current smoothed by a smoothing capacitor C1 (C2, C3, and C4) is supplied to a load LD1 (LD2, LD3, and LD4) an end of which is connected to GND. The current balancing device further includes a resistor Rs as a current detector between the load LD1 (LD2, LD3, and LD4) and a secondary winding Ns. The connection point of the secondary winding Ns and the resistor Rs is connected to an input end of a filter circuit composed of a resistor Ris and a capacitor Cis. One of input terminals of a PRC circuit 1 as a comparison circuit and a control circuit is connected to an output end of the filter circuit, and the other input terminal is connected to a reference voltage Vref which is negative.

The resistor Rs detects currents flowing through the loads LD1, LD2, LD2, and LD3 collectively and outputs the current detection value to the PRC circuit 1 through the filter circuit. The PRC circuit 1 compares the current detection value with the reference voltage Vref and controls the ratio of on time of the switching element QH to on time of the switching element QL based on the error output thereof so that the currents flowing through the loads are held constant.

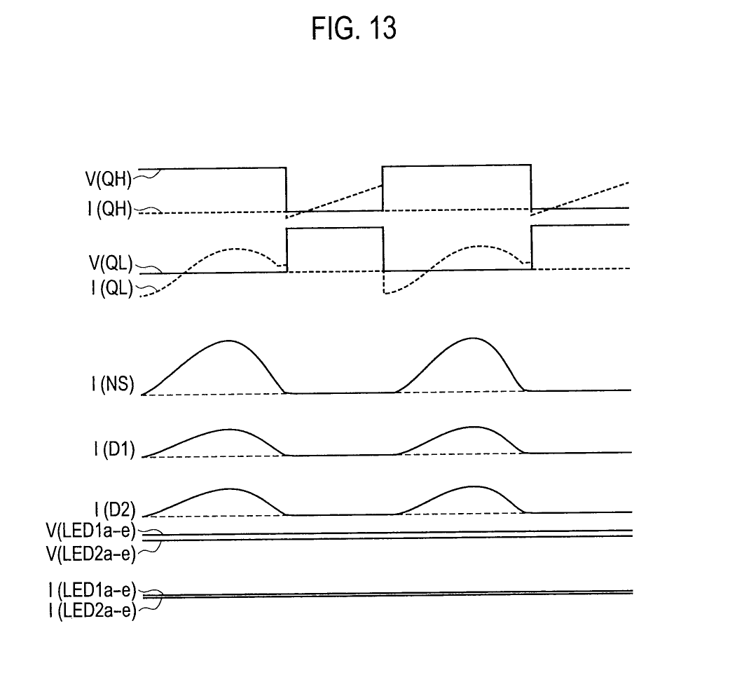

The waveform of each portion is basically the same as that shown in FIG. 13, and a description thereof is omitted.

According to the current balancing device of Embodiment 12, it is possible to obtain a similar effect to that of the current balancing device according to Embodiment 9 and to control and hold the current flowing through the load LD1 (LD2, LD3, and LD4) constant. Moreover, an end of each load is directly connected to the GND potential. Accordingly, noise generated in the current balancing device can be reduced at low cost.

Note that the current detector, the comparator, and the controller according to Embodiment 12 can be applied to the multiple series circuits shown in Embodiments 2 to 5. In addition, the filter circuit can be omitted.

### Embodiment 13

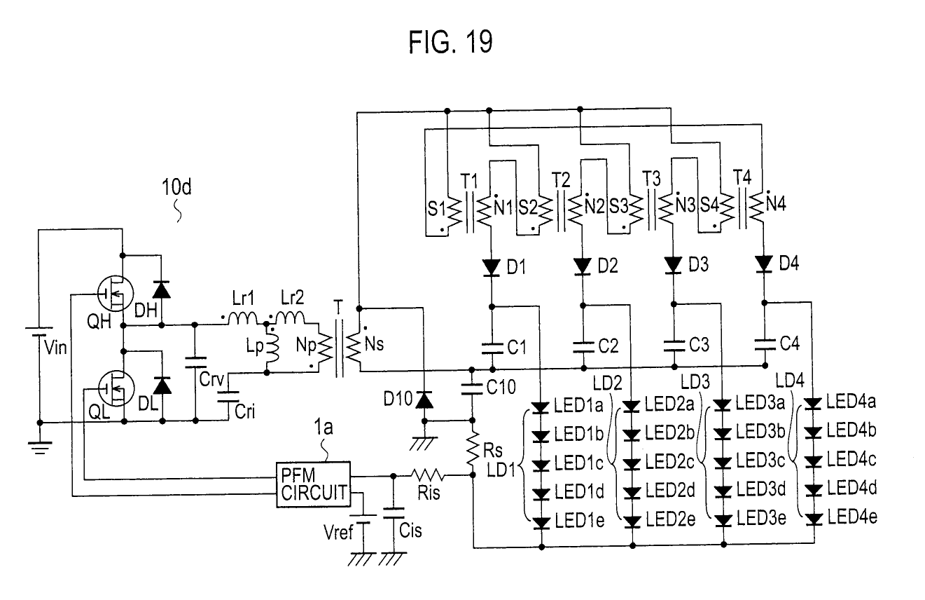

FIG. 19 is a configuration diagram of a current balancing device according to Embodiment 13 of the present invention, which is characterized by including: a current detector for detecting currents of the multiple series circuits; a comparator for comparing a detection value detected by the current detector with a reference voltage; and a controller for controlling the alternating current according to the output of the comparator.

The current balancing device according to Embodiment 13 shown in FIG. 19 includes a power supply unit 10d having the same configuration as that of the power supply unit 10a according to Embodiment 6. The output of the power supply unit 10d is connected to the series circuits according to Embodiment 2. The capacitor C10 and diode D10 according to Embodiment 10 are provided. Moreover, a resistor Rs as a current detector is added between the load LD1 (LD2, LD3, and LD4) and the connection point of the capacitor C10 and diode D10. The connection point of the load LD1 (LD2, LD3, and LD4) and the resistor Rs is connected to an input end of a filter circuit composed of a resistor Ris and a capacitor Cis. One of input terminals of a PFM circuit 1a serving as a comparison circuit and a control circuit is connected to an output end of the filter circuit, and the other input terminal thereof is connected to a reference voltage Vref which is positive.

The resistor Rs detects currents flowing through the loads LD1, LD2, LD3, and LD4 collectively and outputs a current detection value to the PFM circuit 1a through a filter circuit. The PFM circuit 1a compares the current detection value and the reference voltage Vref and controls the on-off frequency of the switching elements QH and QL based on an error output thereof so that the currents flowing through the loads are held constant.

Note that the waveform of each portion is basically the same as that shown in FIG. 15, and the description thereof is omitted.

According to the current balancing device of Embodiment 13, it is possible to provide the same operational effect as that of the current balancing device according to Embodiment 12. Embodiment 13 shown in FIG. 19 is characterized in that the reference voltage Vref is positive while the reference voltage Vref is negative in Embodiment 12 shown in FIG. 18. Since the reference voltage can be set positive, a negative voltage is unnecessary, and the configuration of the detector can be simplified. The detector can be therefore configured at low cost.

Note that the current detector, the comparator, and the controller according to Embodiment 13 can be applied to the multiple series circuits shown in Embodiments 2 to 5. In addition, the filter circuit can be omitted.

### Embodiment 14

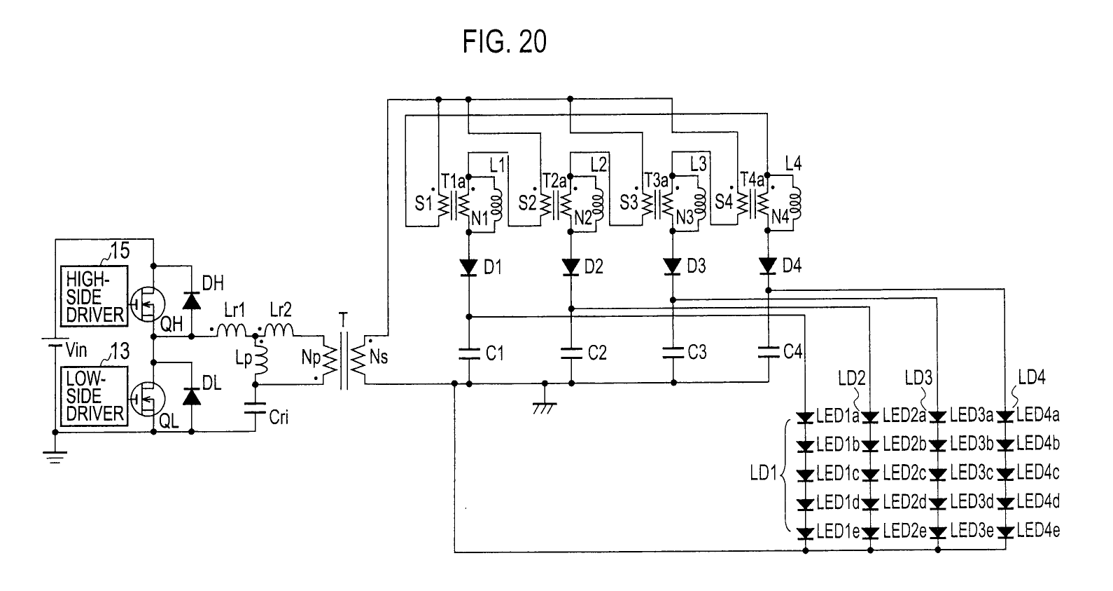

FIG. 20 is a configuration diagram of a current balancing device according to Embodiment 14 of the present invention. Compared to the circuit diagram of Embodiment 9 shown in FIG. 12, the circuit diagram of Embodiment 14 shown in FIG. 20 includes more series circuits connected in parallel, and the balancing transformers are separately shown as ideal transformers T1a, T2a, T3a, and T4a and magnetizing inductances L1, L2, L3, and L4. In Embodiment 14, an operation of resetting the transformers T1a, T2a, T3a, and T4a, and control of turning off the switching element QL are mainly described.

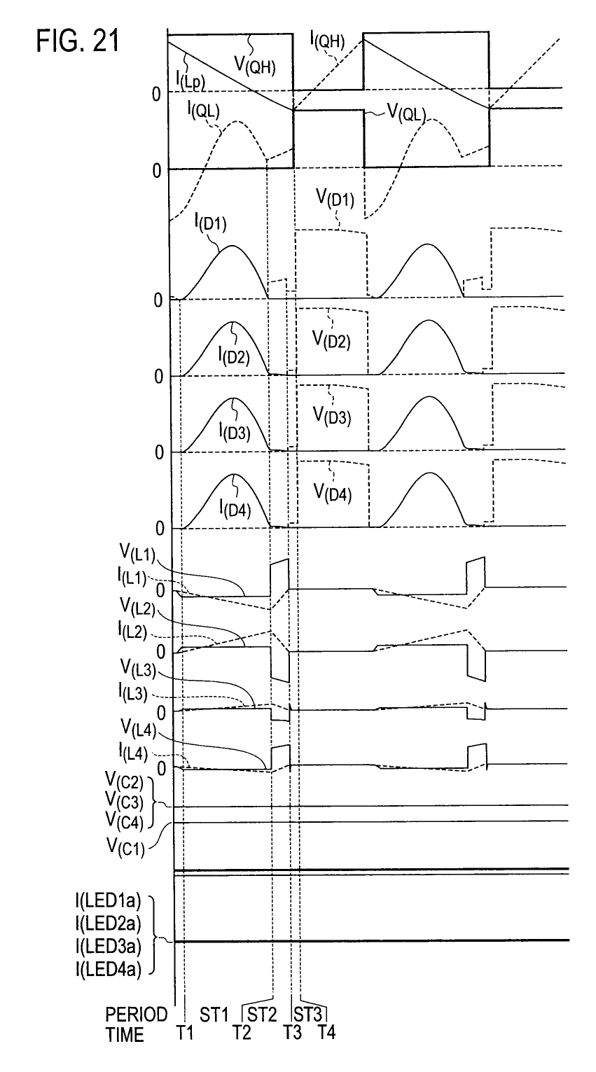

FIG. 21 shows operational waveforms for explaining a reset operation of the balancing transformers of the current balancing device according to Embodiment 14 of the present invention.

In FIG. 21, ST1 denotes a period when the current supplied from the primary winding Np is flowing from the secondary winding Ns; ST2, a period when the transformers T1a, T2a, T3a, and T4a are reset; and ST3, a period when reset of the transformers T1a, T2a, T3a, and T4a is finished and the switching element QL is turned off.

In the period ST1, the current from the secondary winding Ns flows through a first path of Ns→S2→N1→D1→C1→Ns, a second path of Ns→S3→N2→D2→C2→Ns, a third path of Ns→S4→N3→D3→C3→Ns, and a fourth path of Ns→S1→N4→D4→C4→Ns. Accordingly, the current flowing through the primary winding N1 is equal to the current flowing though the secondary winding S1, and the current flowing through the primary winding N2 is equal to the current flowing through the secondary winding S2. The currents flowing through the first to fourth paths are therefore equal.

The voltages of the above paths during the period ST1 are:

Vc1=Vns+Vs2−Vn1−Vf

Vc2=Vns+Vs3−Vn2−Vf

Vc3=Vns+Vs4−Vn3−Vf

Vc4=Vns+Vs1−Vn4−Vf,

where
Vcm is a voltage of the smoothing capacitor Cm (m is an integer of 1 to 4) (which is equal to the sum of forward voltage drops of LEDs ma to me),
Vns is a voltage of the winding Ns,
Vsm is a voltage of the winding Sm (m is an integer of 1 to 4),
Vnm is a voltage of the winding Nm (m is an integer of 1 to 4),
Vf is a forward voltage drop of the diode Dm (m is an integer of 1 to 4).

### Herein, Vn1=Vs1, Vn2=Vs2, Vn3=Vs3, and Vn4=Vs4.

Vc is an average of Vc1, Vc2, Vc3, and Vc4 and is expressed as:

Vc=(Vc1+Vc2+Vc3+Vc4)/4

Vns=Vc+Vf

The voltage across the two windings connected in series in each path is:

Vs2−Vn1=Vc1−Vc

Vs3−Vn2=Vc2−Vc

Vs4−Vn3=Vc3−Vc

Vs1−Vn4=Vc4−Vc.

When the voltage Vc1, i.e., the sum of the forward voltage drops of LEDs 1a to 1e, is larger than the average value of the sums of the forward voltage drops of the LEDs ma to me, Vc1−Vc is positive, and the positive voltage is applied to the series circuit composed of the windings S2 and N1.

Meanwhile, when the voltage Vc1, i.e., the sum of the forward voltage drops of the LEDs 1a to 1e is smaller than the average value of the sums of the forward voltage drops of the LEDs ma to me, Vc1−Vc is negative, and the negative voltage is applied to the series circuit of the windings S2 and N1.

When Vcm (m is one of 1 to 4) is smaller than the average value Vc, a positive current flows through the corresponding magnetizing inductance Lm. When Vcm is larger than the average value Vc, a negative current flows through the corresponding magnetizing inductance Lm.

In the period ST2, the currents stored in the magnetizing inductances L1 to L4 of the balancing transformers T1a to T4a are reset. The negative currents stored in the magnetizing inductances L1 to L4 during the period ST1 generate a voltage opposite to the forward voltage of the diode Dm, and the diode Dm is subjected to a reverse voltage.

The conceivable condition for generating the largest reverse voltage during the reset period ST2 is that the deviation of Vc1, i.e., the sum of the forward voltage drops of the LEDs 1a to 1e, has a maximum value. In such a case, for example, it is considered that each of the deviations of the other Vc2, Vc3, and Vc4, i.e., the sums of the forward voltage drops of the LEDs xa to xe (x=2 to 4), has a minimum value. This is the case where the reverse voltage is applied to only the diode D1 during the reset period ST2.

The reverse voltage of the diode D1 in the aforementioned case is expressed as:

VD1=Vc1−Vns−Vn2+Vn1.

The forward voltages in the other second to fourth paths are expressed as:

Vc2=Vns+Vn3−Vn2−Vf

Vc3=Vns+Vn4−Vn3−Vf

Vc4=Vns+Vn1−Vn4−Vf

Accordingly, from the above three equations,

Vn1−Vn2=Vc2+Vc3+Vc4−3Vns+3Vf

The reverse voltage of the diode D1 is:

VD1=Vc1+Vc2+Vc3+Vc4−4Vns+3Vf

This reveals that the voltage of the diode to which the reverse voltage is applied during the reset period ST2 is small when the winding voltage Vns is positive.

In the operation waveforms shown in FIG. 21, the current of the secondary winding has a sinusoidal waveform, and the switching element QL is not turned off during the period ST2 (when the balancing transformers are reset) even after the current of the secondary winding becomes zero. Accordingly, the secondary winding voltage Vns slightly decreases during the reset period ST2. However, the secondary winding voltage Vns decreases only by a very small amount compared to that during the period when currents are flowing through the diodes. If Vns is expressed as Vc−ΔV, ΔV is the above very small decrease. Accordingly,

VD1=Vc1+Vc2+Vc3+Vc4−4Vns+3Vf

VD1=4Vc−4(Vc−ΔV)+3Vf=4ΔV+3Vf.

Thus, the reverse voltage across the diode D1 can be suppressed to be low. Specifically, the switching element QL is turned off at time T4 after time T3 when the current flowing through the inductance L1 (L2, L3, and L4) becomes zero and the period to reset the balancing transformers T1a to T4a is terminated. Thereby, the reverse voltage of the diode D1 can be suppressed to be low.

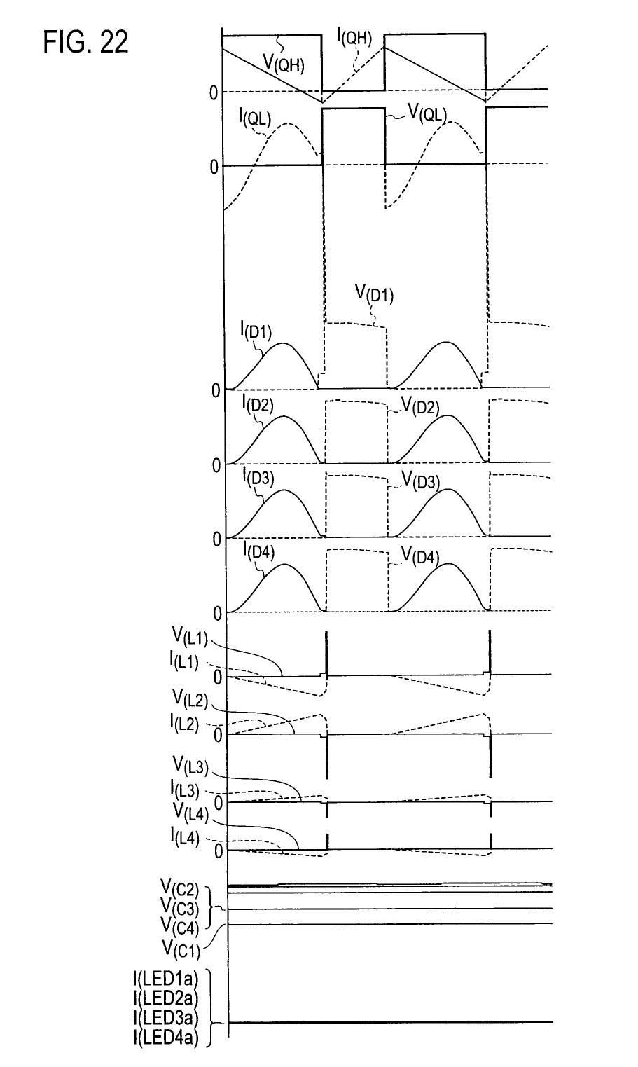

FIG. 22 shows an operation waveform of each portion when the switching element QL of the current balancing device according to Embodiment 14 of the present invention is turned off during the period ST2 to reset the balancing transformers T1a to T4a.

If the switching element QL is turned off during the period ST2 to reset the balancing transformers T1a to T4a, the current having flown to the magnetizing inductance Lp starts to flow to the diode DH. The beginning of the primary winding of the transformer T then has a negative voltage, and the beginning of the secondary winding of the transformer T also has a negative voltage. Accordingly, Vns is expressed as:

Vns=(Vin−Vcri)/N,

where
N is turn ratio of the transformer T.
The reverse voltage of the diode D1 becomes very high value like:

VD1=Vc1+Vc2+Vc3+Vc4+4(Vin−Vcri)/N+3Vf.

FIG. 22 also shows that the voltage V(D1) of the diode D1 is very high.

As apparent from the above equation, since Vc1 is approximately equal to the total voltage of Vf of LED units (Vf of the LED units×the number of LED units connected in series), the reverse voltage across the diode D1 increases as the number of LED units connected in series increases.

Meanwhile, increasing the number of LED units connected in parallel requires high voltage diodes or restricts the breakdown voltage of the diodes. Accordingly, the number of LED units connected in series and the number of LED units connected in parallel cannot be increased. It is therefore very effective to control on and off of the switching elements QL and QH during the reset period ST2 so as to reverse the voltage of the transformer after the reset of the balancing transformers is finished.

### Embodiment 15

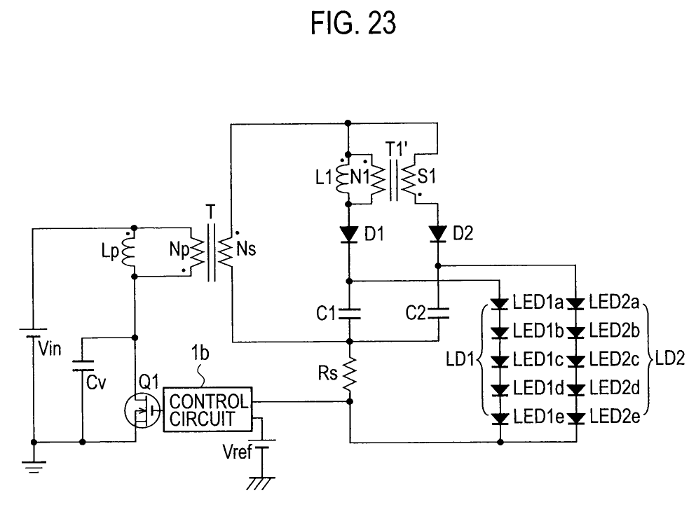

FIG. 23 is a configuration diagram of a current balancing device according to Embodiment 15 of the present invention. This embodiment is characterized in that a switching element Q1 is turned on to terminate the voltage resonance after the reset period is terminated, so that a reverse voltage is suppressed to be low.

In Embodiment 15 shown in FIG. 23, compared to Embodiment 8 shown in FIG. 10, the transformer T is separately shown as a magnetizing inductance Lp and an ideal transformer. A resonant capacitor Cv configured to make a voltage resonance with the magnetizing inductance Lp after the current of the winding Ns becomes zero is connected to a switching element Q1 in parallel. The balancing transformer is separately shown as an ideal transformer T1′ and a magnetizing inductance L1. The capacitor Cv may be a parasitic capacitance of the FET (switching element Q1). In Embodiment 15, the reset of the magnetizing inductance L1 of the transformer T1′ and control of turning on the switching element Q1 are mainly described.

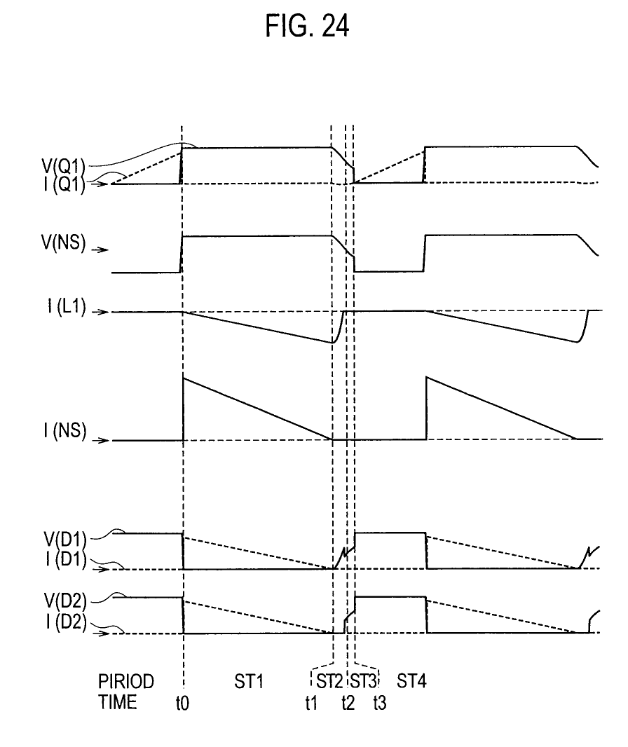

FIG. 24 shows an operation waveform of each portion when the switching element Q1 of the current balancing device of Embodiment 15 of the present invention is turned off during the period to reset the balancing transformer T1′.

In FIG. 24, before time t0, the switching element Q1 is on, and the beginning of the primary winding Np has a negative voltage of −Vin. The beginning of the secondary winding Ns then also has a negative voltage, and the diodes D1 and D2 are subjected to reverse voltages. Accordingly, there is no current flowing through the secondary winding Ns. The current on the primary side flows in the path of Vin→Lp→Q1→Vin, and the magnetizing inductance Lp stores energy.

When the switching element Q1 is turned off at the time t0, the energy stored in the magnetizing inductance Lp generates counter-electromotive force, and the beginning of the winding Np then has a positive voltage. Accordingly, the beginning of the winding Ns has a positive voltage, and a current flows through the secondary winding Ns. The current on the primary side flows in the path of Lp→Np→Lp while currents on the secondary side flow in the paths of Ns→N1→D1→C1→Ns and Ns→S1→D2→C2→Ns. The currents are smoothed by the smoothing capacitors C1 and C2 and then flow to the loads LD1 and LD2.

As described in Embodiment 8, the balanced currents flow through the windings N1 and S1. At time t1, the energy stored in the magnetizing inductance Lp becomes zero, and the current I(NS) flowing through the winding Ns becomes zero. In the periods ST2 and ST3, during the period where the energy stored in the resonant capacitor Cv makes the voltage resonance with the magnetizing inductance Lp, the voltage of the winding Np gradually decreases because of the voltage resonance. Accordingly, the voltage of the winding Ns also gradually decreases, and the reverse voltage applied to the diodes D1 and D2 can be therefore reduced as shown in Embodiment 14. The switching element Q1 is turned on at time T3 to terminate the resonance period. The period ST2 is a period when the magnetizing inductance L1 of the transformer T′ is reset.

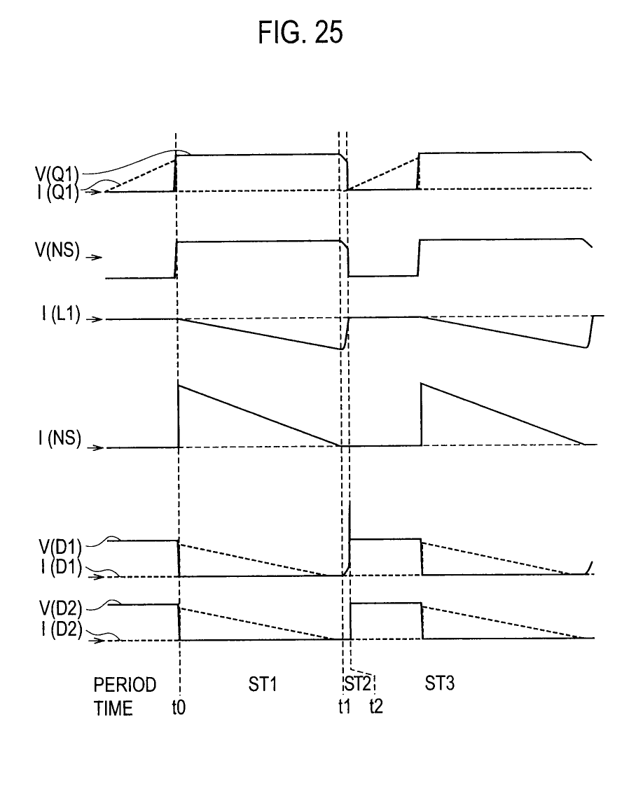

In contrast, FIG. 25 shows an operation waveform obtained by turning on the switching element Q1 at the time t2 before the reset period is terminated in the current balancing device according to Embodiment 15. The diode D1 is subjected to a large reverse voltage like Embodiment 8. Accordingly, a problem occurs in breakdown voltage of the diode as described in Embodiment 14.

In the current balancing device according to Embodiment 15, the reverse voltages applied to the diodes D1 and D2 can be suppressed to be low. This makes it possible to use low voltage diodes or eliminate the diodes. The current balancing device can be therefore configured at low cost.

### Embodiment 16

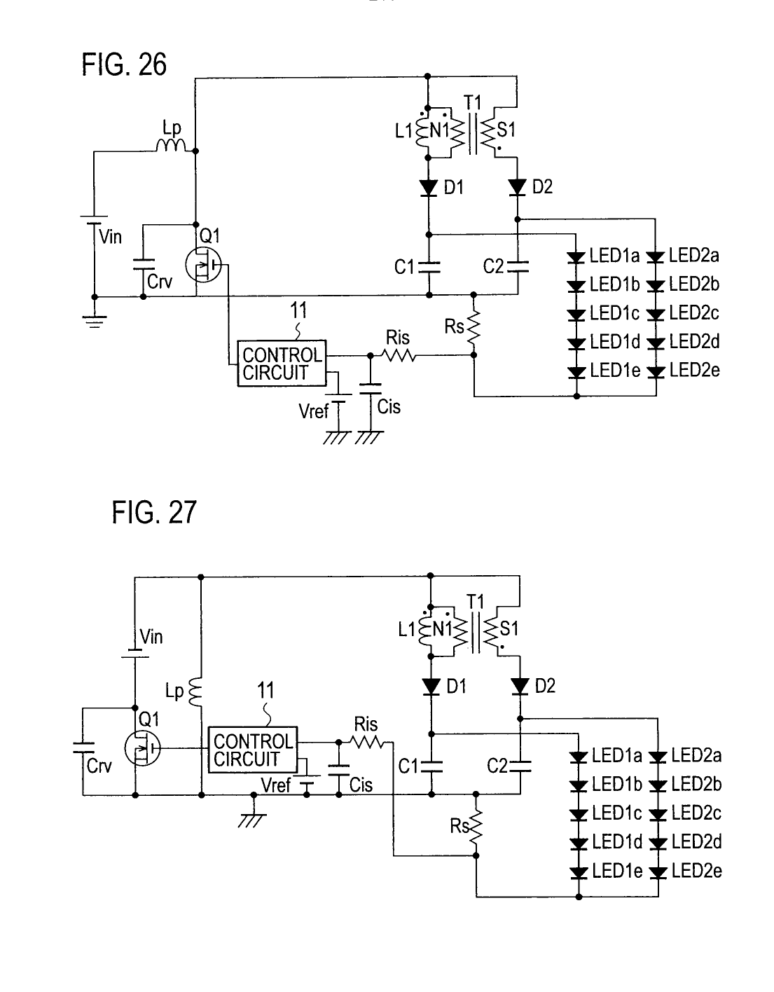

FIG. 26 is a configuration diagram of a current balancing device according to Embodiment 16 of the present invention. Embodiment 16 shown in FIG. 26 is characterized in that the current from the magnetizing inductance Lp is taken out without the transformer Tin Embodiment 15 shown in FIG. 23. The current balancing device of Embodiment 16 has the same operation as Embodiment 15, a description of which is omitted herein, and can provide an equivalent effect to that of Embodiment 15. Moreover, compared to the current balancing devices according to Embodiments 1, 6, and 7, the transformer T can be eliminated from the power supply unit of Embodiment 16, and the current balancing device of Embodiment 16 can be therefore configured at low cost.

### Embodiment 17

FIG. 27 is a configuration diagram of a current balancing device according to Embodiment 17. Embodiment 17 shown in FIG. 27 is obtained by modifying the connection of the magnetizing inductance Lp, the power supply Vin, and the switching element Q1 in Embodiment 16 shown in FIG. 26 and can provide the same effect as that of Embodiment 16.

Moreover, it is possible to use a combination of some of the connection configuration of the balancing transformers shown in Embodiments 2 to 5. Furthermore, the current detector shown in Embodiments 12 and 13 may be configured to detect the current of the closed loop shown in Embodiment 3.

The current balancing device of the present invention can be applied to, for example, LED lighting apparatuses, LCD backlight (LCD B/L) modules, and LCD display units.

An LED lighting apparatus includes: a power converter configured to convert alternating current power from a commercial power supply into arbitrary alternating current power and to supply the alternating current; and a current balancing device in which currents each flowing through a corresponding one of multiple series circuits and at least one LED load are balanced based on an electromagnetic force generated at least one winding, the multiple series circuits being connected to an output of the power converter and each including the at least one winding, at least one rectifying element and the at least one LED load, which are connected in series.

An LCD B/L module includes an LCD cell and a current balancing device in which currents each flowing through a corresponding one of multiple series circuits and at least one LED load are balanced based on an electromagnetic force generated at least one winding, the multiple series circuits being connected to an output of a power converter and each including at least one winding, at least one rectifying element and at least one LED load for lighting the LCD cell, which are connected in series, the power converter converting alternating current power from a commercial alternating current power supply into arbitrary alternating power and then supplying the alternating current.

An LCD display unit includes: an LCD cell; a power converter configured to convert alternating current power from a commercial alternating current power supply into an arbitrary alternating current power and to supply the alternating current; a current balancing device in which currents each flowing through a corresponding one of multiple series circuits and at least one LED load are balanced based on an electromagnetic force generated at least one winding, the multiple series circuits being connected to an output of a power converter and each including at least one winding, at least one rectifying element and at least one LED load for lighting the LCD cell, which are connected in series. The LCD display unit is used in televisions, monitors, billboards, and the like.

### Embodiment 18

Next, a description is given of a current balancing device of Embodiment 18. When a rectifying element is connected to a balancing transformer in order to rectify a current from the balancing transformer, in some cases, a counter-electromotive force is generated when the balancing transformer is reset, and the rectifying element is subjected to a large reverse voltage.

When the rectifying voltage (voltage of the rectifying element) is lower than the voltage of a secondary winding of a main transformer, the rectifying element connected to the balancing transformer is subjected to a current so as to be turned on at the reset of the balancing transformer. In contrast, when the rectifying voltage (voltage of the rectifying element) is higher than the voltage of the secondary winding of the main transformer, a counter-electromotive force is generated in a direction in which a reverse voltage is applied to the rectifying element at the reset of the balancing transformer. For suppressing the reverse voltage to be low, the circuit system and operation condition of the main circuit are restricted, thus resulting in a lower efficiency of the main circuit or an increase in size of the transformer of the main circuit.

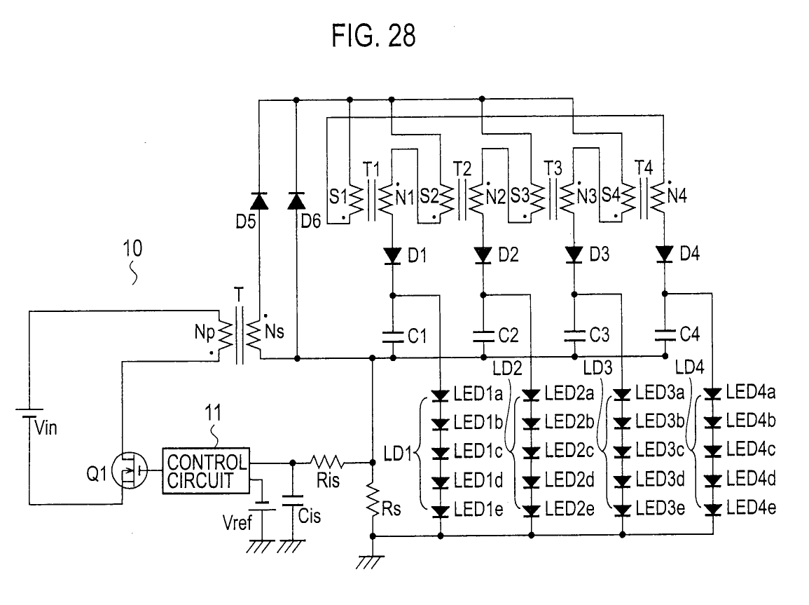

In the current balancing device of Embodiment 18, a reverse voltage applied to a rectifying element connected to a balancing transformer in series is reduced. FIG. 28 is a configuration diagram of a current balancing device of Embodiment 18 of the present invention. The current balancing device of Embodiment 18 includes: the power supply unit 10 shown in FIG. 1; the multiple series circuits shown in FIG. 18; and diodes D5 and D6.

The multiple series circuits are connected in parallel, and each series circuit includes the windings N1 and S1 (N2, S2 to N4, S4) of the balancing transformer T1 (T2 to T4), the diode D1 (D2 to D4), and the capacitor C1 (C2 to C4). The capacitor C1 (C2 to C4) is connected to the load LD1 (LD2 to LD4) through the resistor Rs.

The cathode of the diode D6 is connected to the balancing transformer T1 (T2 to T4), and the anode of the diode D6 is connected to the capacitor C1 (C2 to C4). The anode of the diode D5 is connected to an end of the secondary winding Ns of the transformer T, and the cathode of the diode D5 is connected to the balancing transformer T1 (T2 to T4).

The current balancing device of Embodiment 18 is characterized as follows. The diode D6 is added thereto, and when the secondary winding Ns of the positive winding has a negative voltage, a reset current is applied to the diode D6 in order to maintain the reset voltage at a certain voltage even when the secondary winding Ns has a negative voltage. The reverse voltage of the diode D1 (D2 to D4) connected to the balancing transformer T1 (T2 to T4) is suppressed to be low, thus achieving a high efficiency of the entire circuit and miniaturization thereof.

Next, a description is given of an operation of the current balancing device of Embodiment 18 configured as described above. First, as for the reverse voltage at the reset, the direction of the generated counter-electromotive force varies depending on the direction of a magnetizing current to be stored of the balancing transformer T1 (T2 to T4). In a steady state, the voltage of the secondary winding Ns of the transformer T of the main circuit is an average of voltage drops of the diodes D1 to D4, i.e., rectified voltages of the diodes D1 to D4 connected to the balancing transformers T1 to T4.

Accordingly, in some cases, the magnetizing current is stored in the direction that the diode D1 (D2 to D4) is charged when the balancing transformer T1 (T2 to T4) is reset (forward bias). In the other cases, the magnetizing current is stored so that the diode D1 (D2 to D4) is subjected to the reverse voltage when the balancing transformer T1 (T2 to t4) is reset (reverse bias).

The reverse voltage of the diode connected to the balancing transformer in series during the reset period has a maximum value Vr regardless of the connection configuration of the balancing transformers when one of the rectified voltages is higher than the average rectified voltage VC and the other rectified voltages are lower than the average rectified voltage VC:

VC1>VC>VC2=VC3 . . . =VCN

Herein, the number of balancing transformers and rectifying circuits connected in parallel is N, and

VC=(VC1+VC2+ . . . VCN)/N

At this time, the reverse voltage Vr1 of the diode D1 connected to the capacitor C1 in series is expressed as:

Vr1=VC1+VC2+ . . . +VCN−N·VNS+N·Vf (1)

VNS is a voltage of the secondary winding NS of the transformer T, and Vf is a forward voltage of the rectifying element.

The reverse voltage Vr1 thus varies depending on the voltage of the secondary winding Ns of the main circuit. In particular, when the voltage (VNS) of the secondary winding Ns of the main circuit becomes negative, the reverse voltage Vr1 is maximized. In other words, when the voltage of the secondary winding Ns of the transformer T is reversed during the period when the balancing transformer T1 (T2 to T4) is reset, a large reverse voltage Vr1 is generated.

In Embodiment 18, when the switching element Q1 is off, a current flows from the secondary winding Ns of the transformer T to the balancing transformer T1 (T2 to T4) through the diode D5.

Next, when the switching element Q1 is turned on and the voltage of the secondary winding Ns of the transformer T is reversed from the positive voltage to the negative voltage, a reset current flows to the balancing transformer T1 (T2 to T4) through the diode D6. In other words, the diode D6 is turned on and thereby the negative voltage of the secondary winding Ns is clamped to the forward voltage Vf.

At this time, the diode D5 is reverse biased, and there is no current flowing from the diode D6 to the diode D5. In other words, the provision of the diode D5 prevents the secondary winding Ns from being short circuited when the switching element Q1 is turned on.

The reverse voltage at the reset in the case where the number of balancing transformers and rectifying elements connected in parallel is N has the maximum value Vr when one rectified voltage is higher than the average rectified voltage VC and the other rectified voltages are lower than the average rectified voltage VC.

This is the case where VC1>VC>VC2=VC3 . . . =VCN,
where VC=(VC1+VC2+ . . . VCN)/N.

At this time, the reverse voltage Vr1 of the diode D1 connected to the capacitor C1 in series is expressed as:

Vr1=VC1+VC2+ . . . +VCN+N·Vf

In the circuit including the diodes D5 and D6, the reverse voltage Vr is −N·VNS (VNS is negative) smaller than that in the circuit not including the diodes 5 and 6. Accordingly, the diode D1 (D2 to D4) connected to the balancing transformer T1 (T2 to T4) can be configured to have a low breakdown voltage. Moreover, the aforementioned effect is not limited by the circuit configuration of the main circuit, the operation conditions thereof, or the configuration of the transformers of the main circuit, and the power supply unit can be therefore reduced in size and cost.

Note that the power supply unit 10 according to Embodiment 18 can be replaced with the power supply unit 10b shown in FIG. 9 or the power supply unit 10c shown in FIG. 18. The multiple series circuits according to Embodiment 18 can be applied to the multiple series circuits shown in Embodiments 1 and 3 to 5.

### Embodiment 19

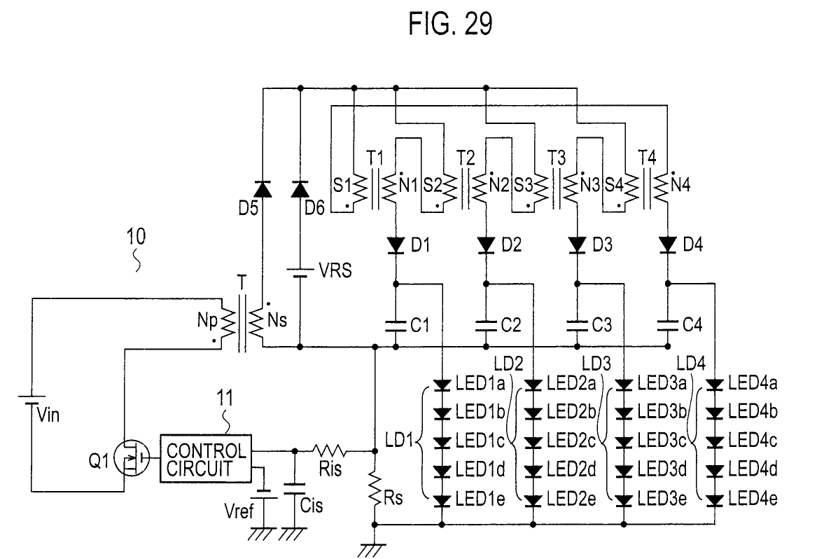

FIG. 29 is a configuration diagram of a current balancing device of Embodiment 19 of the present invention. Compared to Embodiment 18 shown in FIG. 28, Embodiment 19 shown in FIG. 29 is characterized in that the anode of the diode D6, the other end of the secondary winding Ns, and the capacitor C1 (C2 to C4) are connected to a direct current power supply VRS and a reset current is allowed to flow through the diode D6 and the DC power supply VRS.

According to the current balancing device of Embodiment 19, a reverse voltage Vr1 varies depending on the voltage of the secondary winding Ns of the main circuit and is maximized especially when the voltage (VNS) of the secondary winding Ns of the main circuit becomes negative.

In Embodiment 19, when the switching element Q1 is turned on and the voltage of the second winding Ns of the transformer T is reversed from a positive voltage to a negative voltage, a reset current flows from the secondary winding Ns through the voltage source VRS and the diode D6 to the balancing transformer T1 (T2 to T4).

At this time, the reverse voltage Vr1 of the diode D1 connected to the capacitor C1 in series is expressed as:

Vr1=VC1+VC2+ . . . +VCN−N·VRS+N·Vf (2)

Specifically, in the circuit not including the diodes D5 and D6 and the DC power supply VRS, as shown in Equation (1), Vr1 includes −N·VNS. Herein, −N·VNS is positive since VNS is negative, and the reverse voltage Vr becomes high.

In contrast, in the circuit including the diodes D5 and D6 and the DC power supply VRS in Embodiment 19, Vr1 includes −N·VRS as shown in Equation (2). Herein, since VRS is positive, and the reverse voltage Vr1 is therefore low. In other words, the reverse voltage can be reduced by the voltage of the DC power source VRS. Accordingly, the diode D1 (D2 to D4) connected to the balancing transformer T1 (T2 to T4) can be configured to have a low breakdown voltage.

Moreover, the voltage of the DC power source VRS is set to a value smaller than the average of voltages V_{LD1} to V_{LDN} of the loads LD1 to LD4, and thereby the reverse voltage to be applied to the diodes connected to the balancing transformers in series can be made extremely low.

Accordingly, the number of LEDs connected in series in the LED units can be increased, and the number of balancing transformers can be reduced. The number of LED units connected in parallel can be therefore increased, thus reducing the number of transformers (the number of main circuits). It is therefore possible to considerably reduce the costs in a whole circuit and to configure a low-cost LED driver.

Note that the power supply unit 10 according to Embodiment 19 can be replaced with the power supply unit 10b shown in FIG. 9 or the power supply unit 10c shown in FIG. 18. Moreover, the multiple series circuits according to Embodiment 19 can be applied to the multiple series circuits shown in Embodiments 1 and 3 to 5.

### Embodiment 20

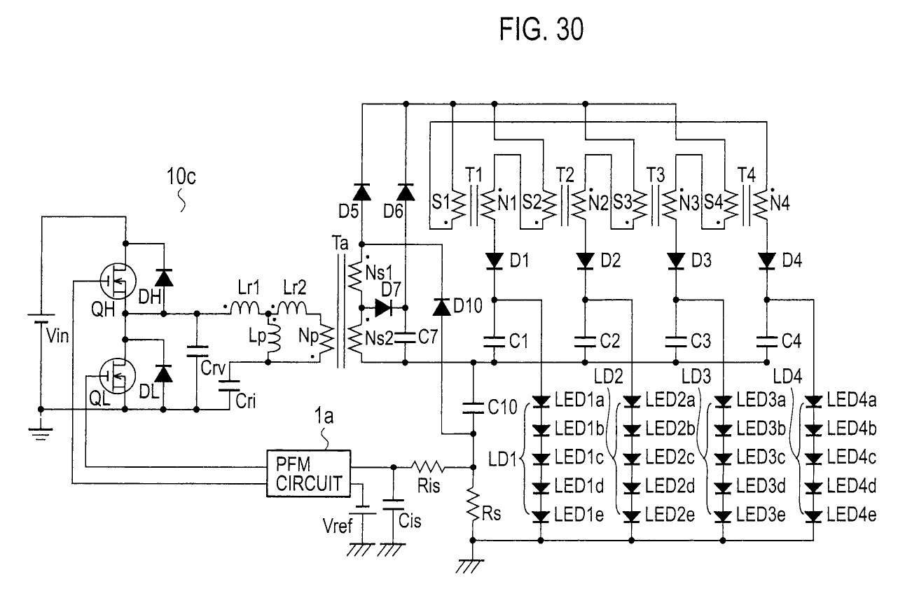

FIG. 30 is a configuration diagram of a current balancing device of Embodiment 20 of the present invention. Embodiment 20 shown in FIG. 30 is characterized as follows, compared to Embodiment 19 shown in FIG. 29. A series circuit including a diode D7 and a capacitor C7 is provided at both ends of a secondary winding Ns2 instead of the DC power supply VRS. In addition, the voltage of the secondary winding Ns2 is rectified and smoothed to obtain a DC voltage.

In Embodiment 20 shown in FIG. 30, compared to Embodiment 19 shown in FIG. 29, the power supply unit 10c shown in FIG. 18 is used instead of the power supply unit 10, and a transformer Ta is used instead of the transformer T. The transformer Ta includes the primary winding Np as well as a secondary winding NS1 and the secondary winding NS2 connected in series.

An end of the secondary winding Ns1 and an end of the secondary winding NS2 are connected to an anode of the diode D7, and a cathode of the diode D7 is connected to the other end of the secondary winding Ns2 and the capacitor C1 (C2 to C4) through the capacitor C7. The cathode of the diode D7 and an end of the capacitor C7 are connected to the anode of the diode D6, and the cathode of the diode D6 is connected to the balancing transformer T1 (T2 to T4). The anode of the diode D5 is connected to the other end of the secondary winding Ns1, and the cathode of the diode D5 is connected to the balancing transformer T1 (T2 to T4).

The other end of the secondary winding Ns1 and the anode of the diode D5 are connected to the cathode of the diode D10, and the anode of the diode D10 is connected to an end of the resistor Rs and an end of the capacitor C10, and the other end of the capacitor C10 is connected to the other end of the secondary winding Ns and capacitor C1 (C2 to C4).

According to Embodiment 20 thus configured, when the switching element QL is turned off from on, the voltage of the secondary winding Ns of the transformer T is reversed from a positive voltage to a negative voltage, and a reset current flows to the balancing transformer T1 (T2 to T4) through the capacitor C7 and the diode D6.

In Embodiment 20, the DC power supply VRS is generated by the diode D7 and the capacitor C7, and the reverse voltage Vr1 is low as similar to Embodiment 19. In other words, the reverse voltage can be suppressed to be low. Accordingly, the diode D1 (D2 to D4) connected to the balancing transformer T1 can be configured to have a low breakdown voltage.

The power supply unit 10c according to Embodiment 20 can be replaced with the power supply unit 10b shown in FIG. 9. The multiple series circuits according to Embodiment 18 can be applied to the multiple series circuits shown in Embodiments 1 and 3 to 5.

### Embodiment 21

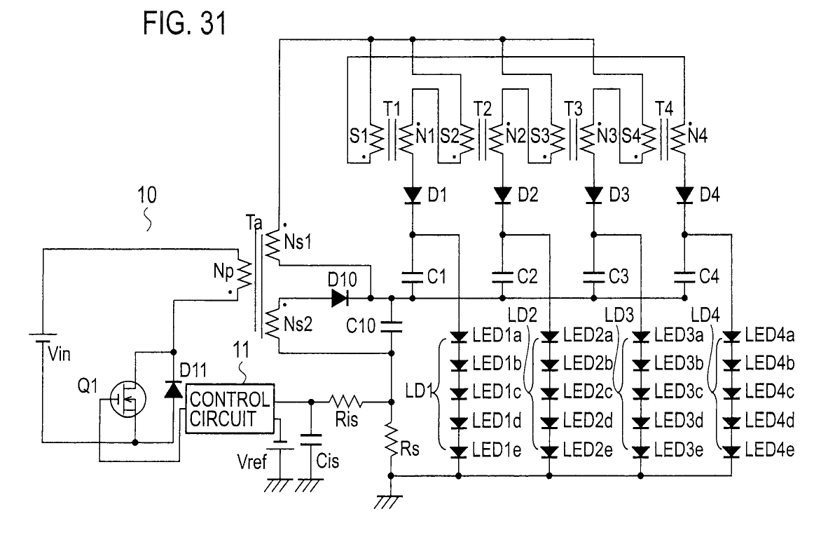

FIG. 31 is a configuration diagram of a current balancing device of Embodiment 21 of the present invention. In Embodiment 21 shown in FIG. 31, the power supply unit 10 is provided, and an end of the secondary winding Ns1 of the transformer Ta is connected to the balancing transformer T1 (T2 to T4). An end of the secondary winding Ns2 is connected to the anode of the diode D10, and the cathode of the diode D10 is connected to the other end of the secondary winding Ns2 through the capacitor C10. The cathode of the diode D10 and the end of the capacitor C10 are connected to the capacitors C1 to C4. The other end of the secondary winding Ns1 is connected to the capacitor C10 and capacitors C1 to C4.

In Embodiment 21, the secondary winding Ns1 is connected to multiple series circuits including the balancing transformer T1 (T2 to T4) and the diode D1 (D2 to D4) which are connected in series. The secondary winding Ns2 is connected to a power source in series which is composed of the diode D10 and capacitor C10. This allows reduction of the numbers of turns of the secondary windings Ns1 and Ns2 of the transformer Ta connected to the balancing transformer T1 (T2 to T4). In other words, the value of VNS of −N·VNS in the equation (1) above is reduced, and thereby the reverse voltage of the diode D1 (D2 to D4) connected to the balancing transformer T1 (T2 to T4) can be reduced.

By contrast, in the current balancing device shown in FIG. 19, the load LD1 is an LED unit including the LEDs 1a to 1e, the load LD2 is an LED unit including the LEDs 2a to 2e, the load LD3 is an LED unit including the LEDs 3a to 3e, and the load LD4 is an LED unit including the LEDs 4a to 4e. The voltage sources whose currents are balanced to be constant by the balancing transformers T1 to T4 are voltages of the capacitors C1 to C4, and these are formed of rectified positive voltages of the secondary winding Ns of the transformer T.

The rectified negate voltage of the secondary winding Ns of the transformer T constitutes a power source composed of the diode D10 and the capacitor C10. Each of the loads LD1 to LD4 is connected to the series circuit of the capacitors C1 to C4 and the capacitor C10.

Like the current balancing device shown in FIG. 19, the reverse voltage of the diode D1 (D2 to D4) connected to the balancing transformer T1 (T2 to T4) can be halved by forming the rectified positive voltage and the rectified negative voltage, even when the single secondary winding Ns is provided. Accordingly, the diode D1 (D2 to D4) connected to the balancing transformer T1 (T2 to T4) can be configured to have a low breakdown voltage.

As described above, according to the embodiments of the present invention, currents supplied from an output of a power supply unit to multiple loads can be balanced based on an electromagnetic force generated at least one winding connected to at least one load in series. Moreover, since the currents are balanced by the electromagnetic force generated at the at least one winding, the loss due to variations of multiple load impedances can be reduced. It is therefore possible to reduce the loss in the circuit balancing the currents flowing through multiple loads having different impedances and to achieve a high efficiency.

The embodiments of the present invention can be applied to LED illumination and LED lighting apparatuses for lighting LEDs, for example, used in backlights of liquid crystal displays.

What is claimed is:

1. A current balancing device comprising:
a power supply unit configured to output an alternating current; and
a plurality of series circuits each connected to an output of the power supply unit, each series circuit including at least one winding, at least one rectifying element, and at least one load, which are connected in series, wherein
currents flowing respectively through the plurality of series circuits are balanced based on an electromagnetic force generated at the at least one winding.

2. The current balancing device according to claim 1, wherein the at least one load has a rectification property.

3. The current balancing device according to claim 1, wherein the alternating current is a sinusoidal half-wave current.

4. The current balancing device according to claim 1, wherein
the power supply unit includes a voltage source, a switch, a reactor, a capacitance element which makes a voltage resonance with the reactor,
the voltage source is connected to the switch and the reactor in series,
the reactor stores energy when the switch is on,
the energy stored in the reactor is outputted as the alternating current when the switch is off,
the capacitance element is connected so as to make the voltage resonance with the reactor after the supplied alternating current becomes zero, and
the switch is turned on after a reset of a magnetizing current of the at least one winding of the plurality of series circuits is finished during the voltage resonance.

5. The current balancing device according to claim 3, wherein
the power supply unit includes a series resonance circuit configured to supply the sinusoidal alternating current, a voltage source, and a plurality of switches, and
one of the plurality of switches is on while the sinusoidal half-wave current is supplied to the plurality of series circuits, and then, the one switch is turned off after the current supplied to the plurality of series circuits becomes zero and the reset of the at least one winding is finished.

6. The current balancing device according to claim 1, wherein a current obtained by smoothing the alternating current is supplied to the load.

7. The current balancing device according to claim 3, wherein a current obtained by smoothing the alternating current is supplied to the load.

8. The current balancing device according to claim 1, further comprising:
a current detector configured to detect the currents flowing through the plurality of series circuits;
a comparator configured to compare a current detection value detected by the current detector with a reference value; and
a controller configured to control the alternating current according to an output of the comparator.

9. The current balancing device according to claim 1, further comprising:
a first series circuit which is connected to the plurality of series circuits in parallel and includes a first rectifying element connected to the output of the power supply unit in series; and
a second rectifying element connected to the plurality of series circuits in parallel.

10. The current balancing device according to claim 3, further comprising:
a current detector configured to detect the currents flowing through the plurality of series circuits;
a comparator configured to compare a current detection value detected by the current detector with a reference value; and
a controller configured to control the alternating current according to an output of the comparator.

11. The current balancing device according to claim 3, further comprising:
a first series circuit which is connected to the plurality of series circuits in parallel and includes a first rectifying element connected to the output of the power supply unit in series; and
a second rectifying element connected to the plurality of series circuits in parallel.

12. An LED lighting apparatus, comprising
the current balancing device according to claim 1, wherein the at least one load is an LED load.

13. An LCD backlight module, comprising
the current balancing device according to claim 1, wherein the at least one load is an LED load causing an LCD cell to emit light.

14. An LCD display, comprising
the current balancing device according to claim 1, wherein
the at least one load is an LED load causing an LCD cell to emit light.

15. An LED lighting apparatus, comprising
the current balancing device according to claim 3, wherein the at least one load is an LED load.

16. An LCD backlight module, comprising
the current balancing device according to claim 3, wherein the at least one load is an LED load causing an LCD cell to emit light.

17. An LCD display, comprising
the current balancing device according to claim 3, wherein
the at least one load is an LED load causing an LCD cell to emit light.
